(19) United States
(12) Patent Application Publication
(10) Pub. No.: US 2007/0064673 A1
(43) Pub. Date: Mar. 22, 2007

(54) Flexible, scalable, wireless data forwarding and mobility for secure wireless networks

(76) Inventors: Nehru Bhandaru, Sudbury, MA (US); John F. Carr, Newton, MA (US); Michael Cook, Lexington, MA (US); Pranab K. Das, Westborough, MA (US); Tom Ermolovich, Lexington, MA (US); Martin Mueller, Shrewsbury, MA (US); Bill Terrell, Tyngsboro, MA (US); Michael Vakulenko, Zichron Yaacov (IL)

Correspondence Address: PERKINS COIE LLP, P.O. BOX 2168, MENLO PARK, CA, 94026, US

(21) Appl. No.: 11/373,863

(22) Filed: Mar. 10, 2006

Related U.S. Application Data
(60) Provisional application No. 60/660,699, filed on Mar. 10, 2005.

(51) Int. Cl. H04L 12/28

(52) U.S. Cl. 370/351; 370/401

(57) ABSTRACT

Systems and methods are described to allow secure undisrupted communication from wireless clients that roam a wide area network. System architectures and communication protocols are provided to ensure that wireless clients can seamlessly associate and reassociate with controllers on the network, without disruption to ongoing secure communications.

### CLAIM OF PRIORITY AND CROSS-REFERENCE TO RELATED APPLICATIONS

The present application claims priority to Bhandaru et. al's U.S. Provisional Patent Application No. 60/660,699 entitled FLEXIBLE, SCALABLE, WIRELESS DATA FORWARDING AND MOBILITY FOR SECURE WIRELESS NETWORKS filed Mar. 10, 2005, the contents of which are hereby incorporated by reference in their entirety.

### FIELD OF THE INVENTION

This invention related to the field of computer networking, and more specifically to the field of protocols for fixed-line and wireless networking.

### BACKGROUND

Definitions

802.11: An IEEE standard for layer 2 wireless local-area networks. Includes 802.11b, 802.11a, and 802.11g, which define the layer 1 physical media behavior of different types of wireless networks.
WiFi: Refers to 802.11
Access Point: A wireless device or a logical function that bridges wireless/802.11 enabled devices from the wireless 802.11 network to the wired networks. Abbreviated AP.
802.16: An IEEE standard for layer 2 wireless networks—Air Interface for Fixed Broadband Wireless Access Systems.
WiMax: Refers to 802.16
Base Station: An 802.16 equivalent of an 802.11 AP. Abbreviated BS.
IETF: Internet Engineering Task Force—a standards body.
CAPWAP: Control and Provisioning of Wireless Access Points. A Group within IETF defining protocols for CAPWAP.
WTP: Wireless Termination Point. The CAPWAP term for an access device with RF Termination.
Local MAC: A centrally controlled wireless architecture where wireless encryption/decryption and bridging of 802.11 to 802.3 is done on the Access Point.
Split AP: Synonym for Local MAC. Split MAC: A centrally controlled wireless architecture where bridging of 802.11 to 802.3 and/or wireless encryption/decryption is done on a centralized device—e.g. Wireless LAN Switch
Ethernet: A widely deployed wired layer 2 technology for connecting devices. Defined by IEEE 802.3.
IP: Internet Protocol, as defined by IETF RFC 791.
GRE: Generic Routing Encapsulation. Defined by IETF RFC 1701 and its variants.
WCP: Wireless Control Plane—A logical entity that provides configuration of wireless network, and control of wireless access to wired networks.
WDF: Wireless Data Forwarder—A logical entity controlled by a WCP that is handling wireless data frames.
WDF element: An entity that configures and/or controls one or more WDF elements.
WDF Control Element: An entity that configures and/or controls one or more WDF elements.
WAA: Wireless Authentication and Association
WAA Control Element: An entity that configures and/or controls WAA, including authorization related to WAA
Wireless Application Coordination: Coordination of a wireless service or wireless management functions across multiple network devices. Examples include coordination of roaming, access policy, and authentication across multiple wireless controllers. Such coordination typically reduces the complexity of using or managing many network devices. It extends a wireless service (e.g. roaming) to span a network of wireless controllers.
WNC: Wireless Network Controller—A device that controls wireless access to wired networks. WNC contains an implementation of WCP and may contain a WDF.
Wireless LAN Switch: A WNC that integrates Layer 2 Switching with Wireless Network functions. Implements Split MAC or Local MAC Architecture and provides support for Wireless Network features such as Mobility, QoS etc.
WCP Community: A collection of WCP entities in a single administrative domain that provide scalable, coordinated control and configuration of a wireless network, and wireless access to wired networks.
MAC layer: Media Access Control layer, also known as Layer 2. Refers to the packet formatting and protocol used to communicate between two devices.
Client: For hardware, refers to a PC, PDA, or other wireless client device. For software, refers to the layer 2 or layer 3 software entity that enables communications on client hardware.
Wireless Station: Synonym for Wireless Client.
Encryption: Scrambling of data to prevent viewing, tampering, and replay from unauthorized sources.
Layer 1: Communications between different devices at the physical layer (e.g., wired, optical, or wireless).
Layer 2: Communications between two devices and the data link layer/MAC layer. Devices may use the same packet formats and MAC layer protocols, but may use different physical media.
Layer 3: Communications between two devices at the network layer, usually implying IP communications. Devices communicating at layer 3 need not use the same layer 2/MAC layer protocols. Layer 3 and IP are used to communicate between different layer 2 devices over the Internet.
Heavyweight Access Point: An access point that implements all of the 802.11 MAC layer for an access point. Typically provides user authentication, encryption, data forwarding, and management capabilities.
Lightweight Access Point: An AP that typically implements only the time-sensitive components of the 802.11 protocol. Some lightweight access points will also implement data encryption. Typically used in conjunction with a wireless LAN switch.
LWAPP: Lightweight Access Point Protocol specified in an IETF Draft.
VLAN: A virtual LAN as defined by IEEE 802
BSS: 802.11 Basic Service Set—a set of wireless stations attached to a single AP and identified by a BSSID.
ESS: An extended service set in 802.11. A logical wireless LAN spanning multiple BSSs.
SSID: Service Set Identifier for an ESS advertised in 802.11 management frames to aid wireless clients in discovering the ESS.
Tunnel: A logical link between two elements of a network. Typically uses encapsulation to traverse diverse or routed networks. e.g. a GRE tunnel between two IP endpoints.
Null Tunnel: A logical tunnel between network elements using no additional encapsulation other than the native encapsulation of the link between them. For example, the network elements directly connected to each other via an Ethernet cable.
802.11i: IEEE 802.11 MAC Layer Security Enhancements
802.11r: IEEE 802.11 Fast BSS Transition Enhancements—under development at IEEE.
Roaming: Wireless clients moving from one radio attachment point to another in a wireless network.
Mobility: A wireless network feature which preserves the current (logical) link between a wireless client and a wireless network. Typically refers to Layer 2 or Layer 3 links.
PFE: Packet Forwarding Engine—A data forwarding abstraction used in this invention implemented in hardware or software.
WiFi VPN: A set of CAPWAP and VPN protocols using WiFi technologies described in U.S. patent application Ser. No. 10/982,598
DSCP: DiffServ Code Point—See IETF RFCs 2475, and 2474.
DS: An 802.11 Distribution System that provides logical services that implement an ESS
IWCPP: Inter WCP Protocol as defined in this invention
HLE: High Level Entity—a term related to IWCPP denoting an application that runs over IWCPP.
Distributed DF (DDF): Distributed Data Forwarding mode as defined in this invention
Centralized DF (CDF): Centralized Data Forwarding mode as defined in this invention
Centralized Hierarchical DF (CHDF): Centralized Hierarchical Forwarding mode as defined in this invention.
X.509: Public Key Certificate format—ISO Standard 9594-8:2001, ITU-T Recommendation X.509, March 2000.
PKI: Public Key Infrastructure

### DESCRIPTION OF THE PROBLEMS SOLVED BY THE INVENTION

The rate at which wireless networks are being deployed is accelerating along with their size and ubiquity. While enterprises, carriers, government and municipality, to name a few, rush to deploy wireless networks, evolving technological standards, lack of flexibility, scalability, and mobility features in today's wireless products makes deployment of wireless networks a challenge.

Wireless networks based on 802.11/WiFi and 802.16/WiMax technology standards comprise a majority of current wireless deployments. Wireless access to wired networks and the Internet is provided by radio devices deployed at the edge of the network. 802.11 Access Points (AP) and 802.16 Base Stations (BS) are examples of these access devices. Using the terminology of CAPWAP, an IETF group defining protocols to address wireless network deployment needs, these access devices are called Wireless Termination Points (WTP).

To facilitate management of large scale wireless networks, deployments are migrating towards centralized management and control of wireless access devices. CAPWAP classifies the centralized architectures for wireless deployment into two categories—Local MAC, and Split MAC. The key distinction between these architectures is that the former terminates 802.11 or 802.16 MAC on the WTP, where as the latter transports wireless frames, potentially encrypted using wireless protocols to a centralized controller. Flexible and scalable support of these two centralized architectures, while providing other features such as security and mobility, needed for wireless deployment, requires flexible system and software designs. Some of the methods to achieve these goals are described in this invention.

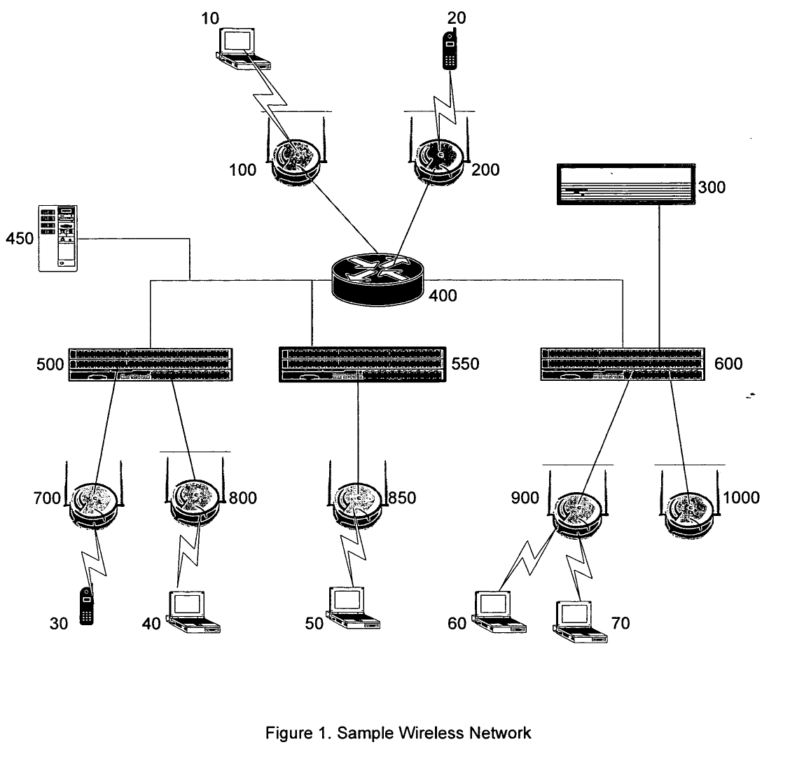

FIG. 1 shows an example centrally controlled wireless deployment. WTPs (100,200,700,800,850,900,1000) providing wireless access to the network. WTPs (850) may be directly connected to their controller (550), via a Layer 2 Ethernet network (WTPs 700,800) to their controller (550) or via a Layer 3 IP network (WTPs 100, 200) to their controller (300).

WTPs may directly place the traffic received over access radio ports from wireless clients on to the network ports. Typically network ports are Ethernet ports, but other types of ports are possible to support—an example of which is a wireless mesh radio port. In FIG. 1, WTP 700 may place wireless client (30) traffic on to its wired Ethernet port connected to switch 500.

Alternatively, WTPs may place traffic received over radio ports from wireless clients on to Layer 2 or Layer 3 tunnels whose other end terminates on a device in the network. For example, in FIG. 1, WTP 800 may tunnel traffic from wireless client 40 over a GRE tunnel to switch 550, that is also its wireless controller. One scenario where this mechanism is used is when the network port on WTP belongs to a different VLAN as compared to the VLAN that is assigned to the wireless client. Typically VLAN is assigned to the wireless client based on its authentication to the network, and may be independent of the VLAN assigned to network ports of the WTP containing the client's radio attachment point.

An important feature of wireless networks is mobility. Mobility features preserve wireless client Layer 2 and/or Layer 3 connection to the network as the client moves its radio attachment point from one WTP to another. In 802.11 networks an ESS, identified by a SSID, represents the logical wireless LAN to which wireless clients may attach themselves and move between any of its BSSs (radio attachment) without necessarily severing the Layer 2 (or Layer 3) link between the client and the network.

For example, in FIG. 1, wireless client 30 may move from WTP 700 to WTP 800. The network ports at WTP 700 and WTP 800 may or may not belong to the same VLAN. Where as WTP 700 may place wireless client 30 traffic directly on to its network port connected to switch 500, WTP 800 may tunnel the traffic to its controller. In this scenario, forwarding state needs to be created on WTP 800, and its controller 550. In addition forwarding state needs to updated or removed on WTP 700. This needs to be done in a manner that preserves the existing Layer 2 connection of the client 30.

In another mobility scenario, wireless client 50 may move its radio attachment point from WTP 850 controlled by 550 to WTP 900 controlled by 300. In this case, controllers 550 and 300 need to coordinate the control of this movement while preserving the existing Layer 2 connection of the client 50.

In order to facilitate mobility, traffic from wireless clients is seamlessly transported from the WTP with client's radio attachment to a location in the network where it may logically enter the wired network or to be delivered to another client on the wireless network. In centralized wireless network architectures, the controller is responsible for setting up the necessary tunneling and forwarding state at one or more devices in the data path between a wireless client, other wireless clients and wired hosts in the network.

In this invention, these devices in the data path controlled by a Wireless Network Controller (WNC) are said to contain a logical entity called the Wireless Data Forwarder (WDF). Relative to each wireless client attachment to the wireless network, three WDFs are logically distinguished
A-WDF—the WDF element controlled by a WNC at the radio attachment point of the wireless client. For 802.11 networks, this is co-located with the AP (BSS) at which the client is currently associated to the network.
I-WDF—the WDF element controlled by a WNC, that is in the data path of the wireless client and where its traffic should not be placed on the network port of the WDF directly.

P-WDF—the WDF element controlled by a WNC where its traffic can be placed on the network port of the WDF directly.

Tunnel setup to support mobility may take time. This time—the tunnel setup latency—should be minimized or eliminated in order to prevent service disruption, and packet loss that results in lower quality of service for wireless clients that use voice services built over the wireless network. Further aggravating latency due to tunnel setup, a mobile client may be required to authenticate at its new radio attachment point. In 802.11 networks this authentication uses 802.1X which may take many seconds to complete, where as requirements of voice clients are of the order of tens of milliseconds.

Standard mechanisms such as 802.11i pre-authentication, and developing standards such as 802.11r attempt to address the authentication latency. With these standards, a wireless client (40 in FIG. 1, for example) attached to a WTP (800) engages in pre-authentication packet exchange with another WTP (850) before it moves its attachment to the other WTP (850). Subsequently it may move to another WTP (900) and use pre-authentication before the move. In this scenario, WNCs 550 and 300 coordinate the pre-authentication process.

As described above, communication between WNCs and WDFs, and between WNCs is necessary to provide wireless network features such as mobility. Such communication needs to be appropriately protected using cryptographic mechanisms. It also should transfer appropriate security state and provide mechanisms to minimize the latency caused by tunnel setup or authentication required as the wireless client roams from one WTP to another in the wireless network.

Current art in the wireless networking field is deficient in flexibility, and protocols to support large scale 802.11/802.16 wireless networks. Although CAPWAP, LWAPP and Mobile IP mechanisms may serve some of the needs that this invention is designed to meet, none will provide flexible, scalable and secure mobility for these wireless networks.

### SUMMARY OF THE INVENTION

This invention comprises flexible and scalable methods for providing mobility for secure wireless networks. In accordance with embodiments of the invention, communications terminals are controlled by a Wireless Network Controller (WNC), each of which contains an entity referred to as the Wireless Data Forwarder (WDF). Relative to each wireless client attachment to the wireless network, three WDFs are logically distinguished:

A-WDF—the WDF element controlled by a WNC at the radio attachment point of the wireless client. For 802.11 networks, this is co-located with the AP (BSS) at which the client is currently associated to the network.

I-WDF—the WDF element controlled by a WNC, that is in the data path of the wireless client and where its traffic should not be placed on the network port of the WDF directly.

P-WDF—the WDF element controlled by a WNC where its traffic can be placed on the network port of the WDF directly.

The invention includes protocols and methods to facilitate message passing and other communication for such entities in order to permit communication from and to mobile wireless terminals. In particular, the invention enables mobile wireless clients to associate and reassociate with controllers in the network in a manner that does not disrupt on-going secure communications conducted with the wireless clients. These and other embodiments of the invention are further described herein.

### BRIEF DESCRIPTION OF THE DRAWINGS

1. FIG. 1 illustrates a Sample Wireless Network

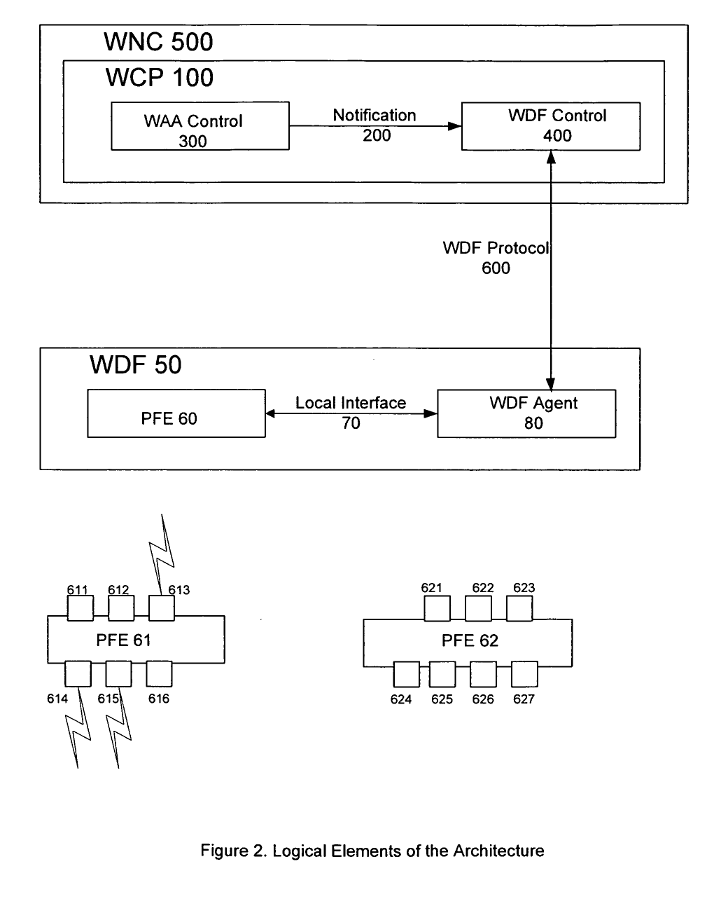

2. FIG. 2 illustrates Logical Elements of the Network Architecture in accordance with embodiments of the invention.

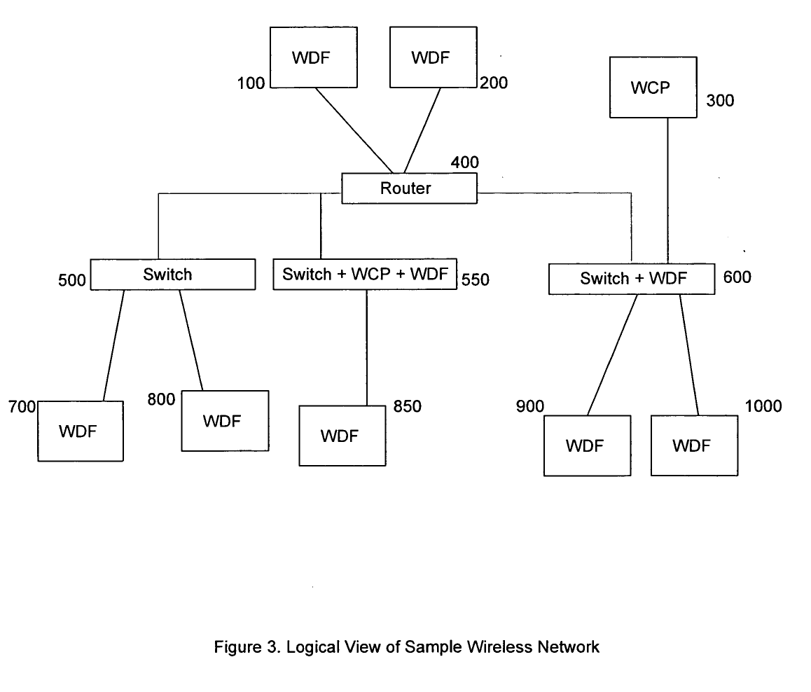

3. FIG. 3 presents a Logical View of Sample Wireless Network

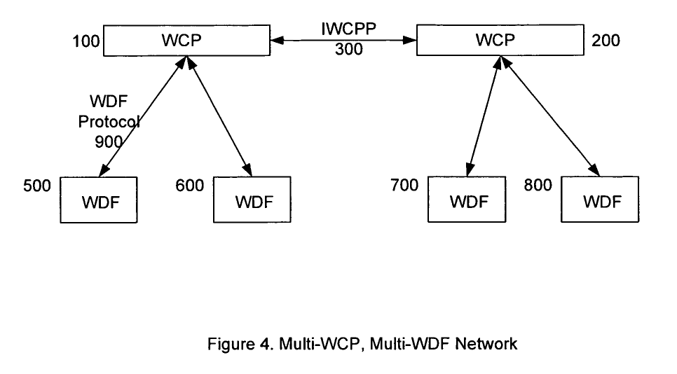

4. FIG. 4 illustrates a Multi-WCP, Multi-WDF Network in accordance with embodiments of the invention.

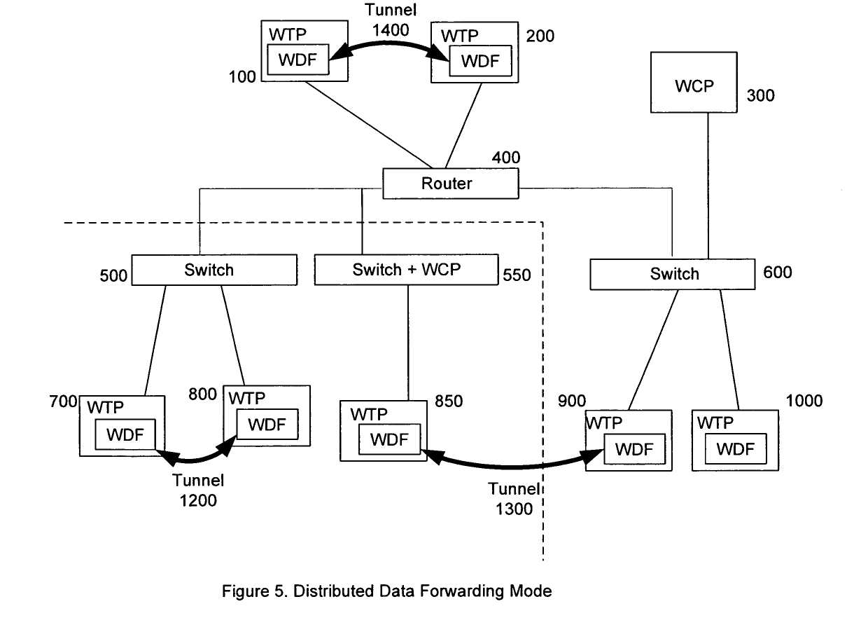

5. FIG. 5 illustrates a Distributed Data Forwarding Mode in accordance with embodiments of the invention.

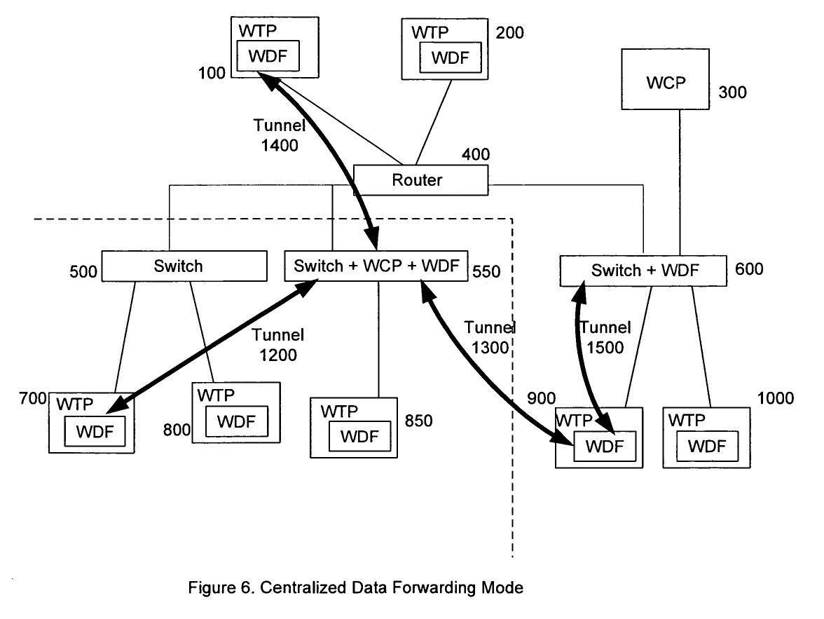

6. FIG. 6 illustrates a Centralized Data Forwarding Mode in accordance with embodiments of the invention.

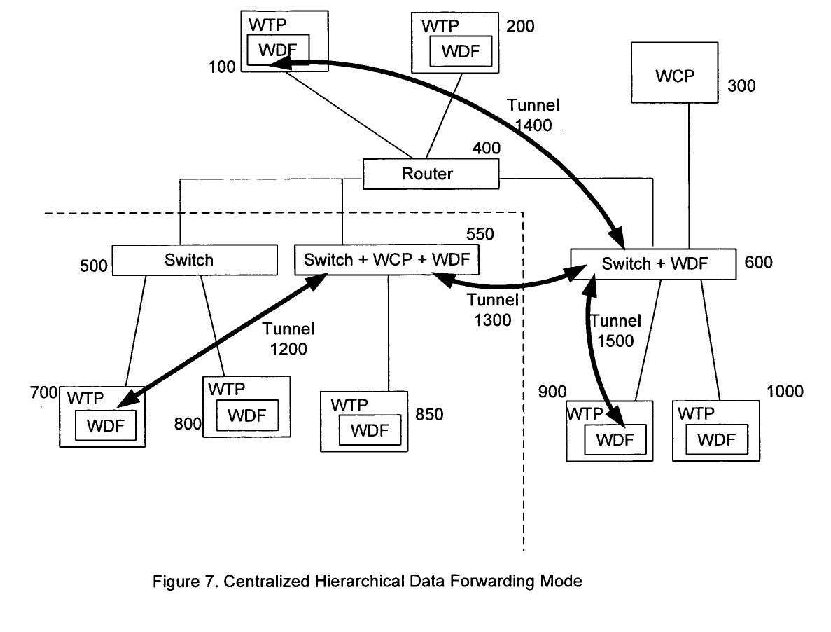

7. FIG. 7 illustrates a Centralized Hierarchical Forwarding Model in accordance with embodiments of the invention.

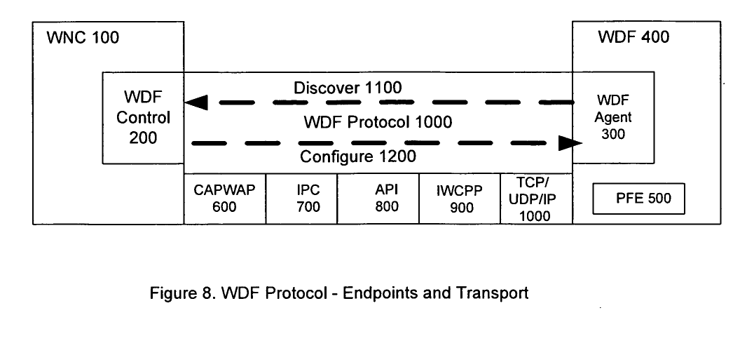

8. FIG. 8 illustrates WDF Protocol—Endpoints and Transport in accordance with embodiments of the invention.

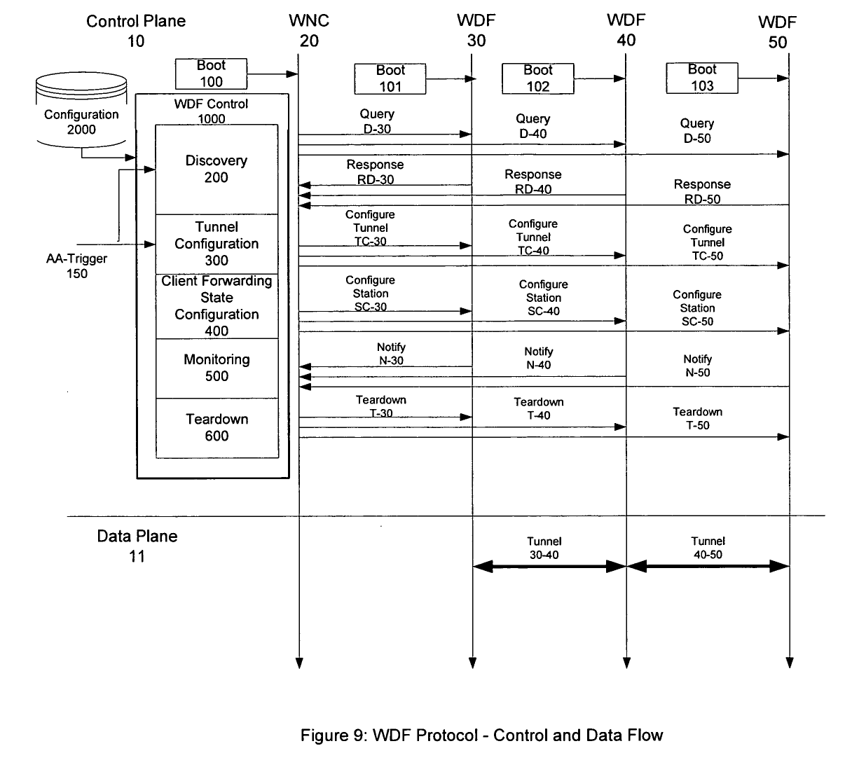

9. FIG. 9 illustrates a WDF Protocol—Control and Data Flow in accordance with embodiments of the invention

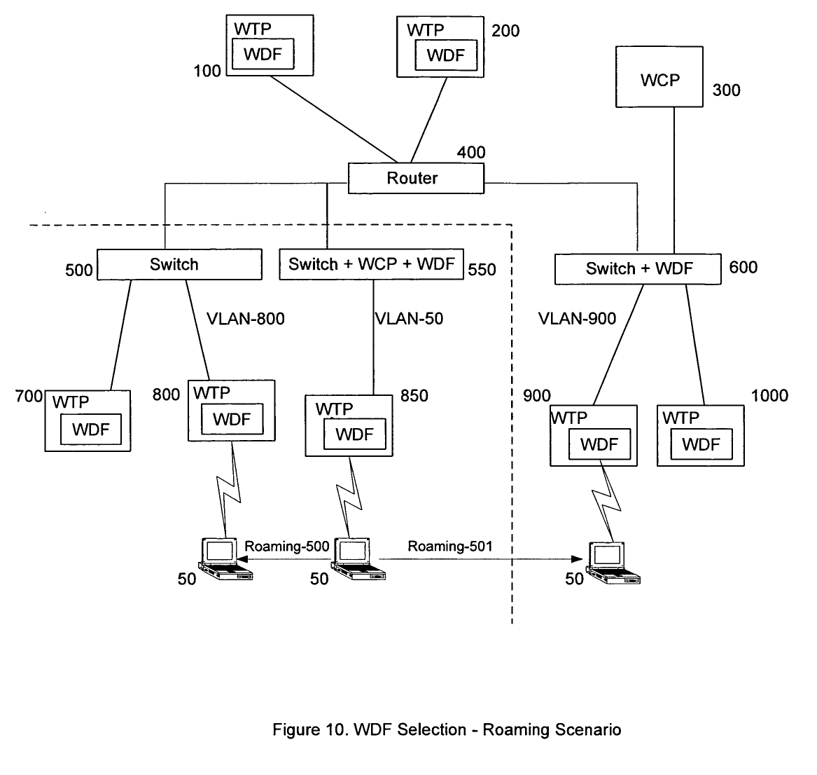

10. FIG. 10 illustrates a WDF Selection—Roaming Scenario in accordance with embodiments of the invention

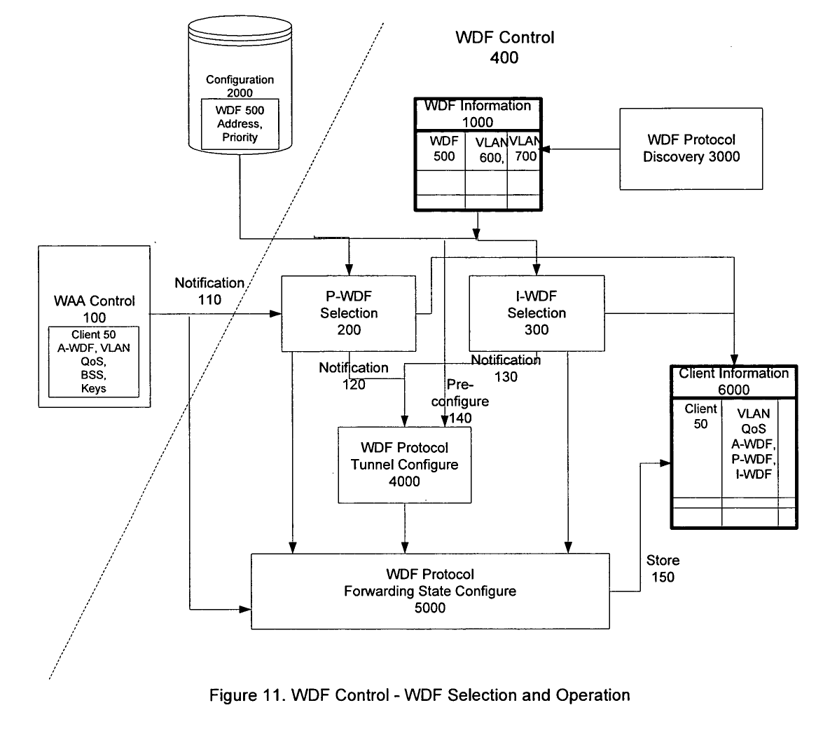

11. FIG. 11 illustrates a WDF Control—WDF Selection and Operation in accordance with embodiments of the invention

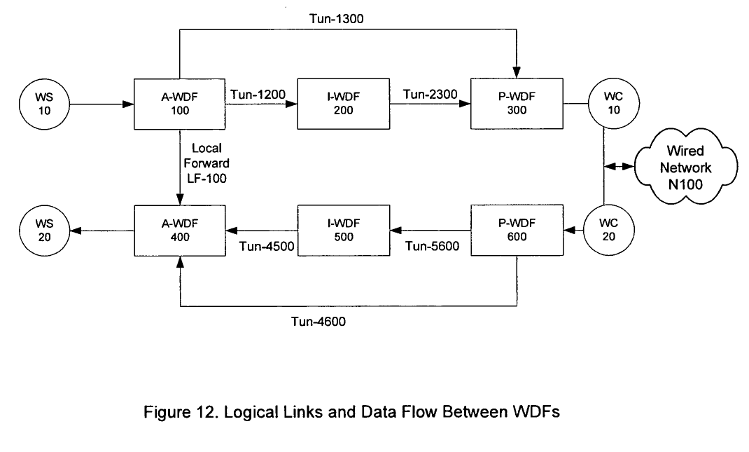

12. FIG. 12 illustrates Logical Links and Data Flow between WDFs in accordance with embodiments of the invention

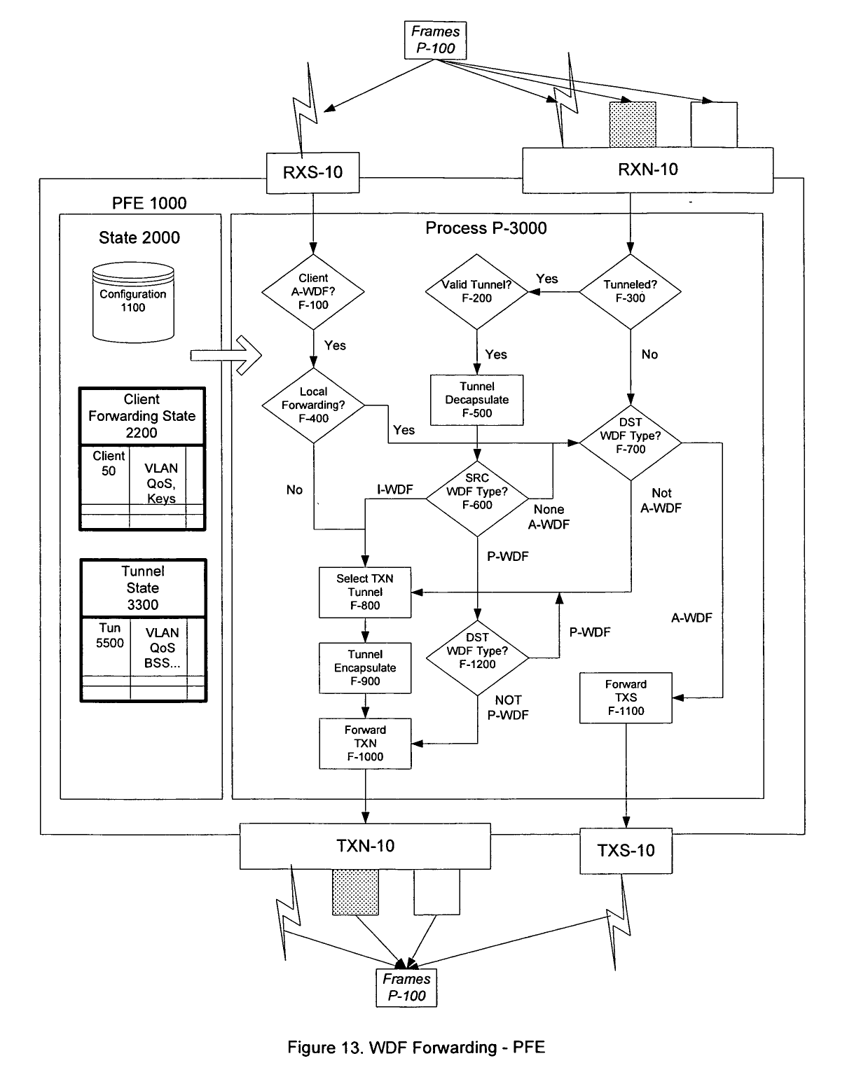

13. FIG. 13 illustrates WDF Forwarding—PFE in accordance with embodiments of the invention

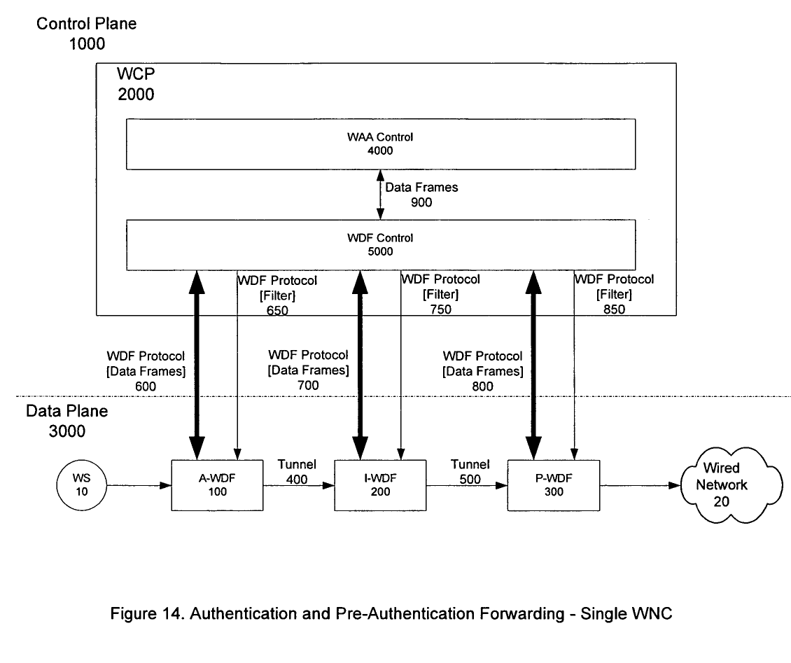

14. FIG. 14 illustrates Authentication and Pre-Authentication Forwarding—Single WNC in accordance with embodiments of the invention

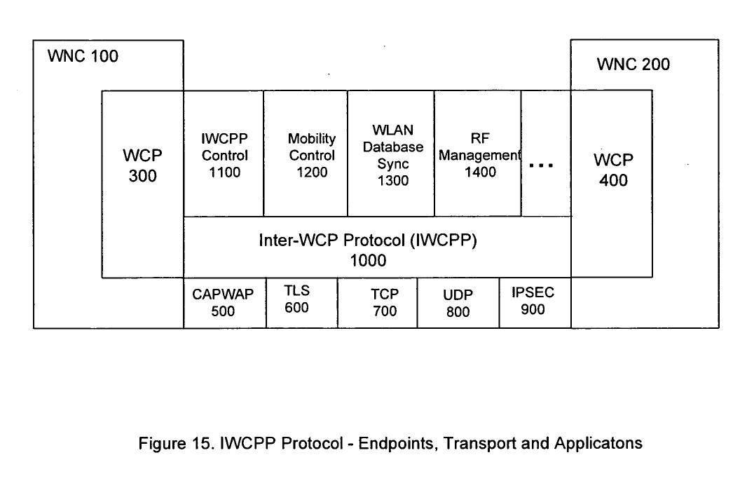

15. FIG. 15 illustrates an IWCPP Protocol—Endpoints, Transport and Applications in accordance with embodiments of the invention

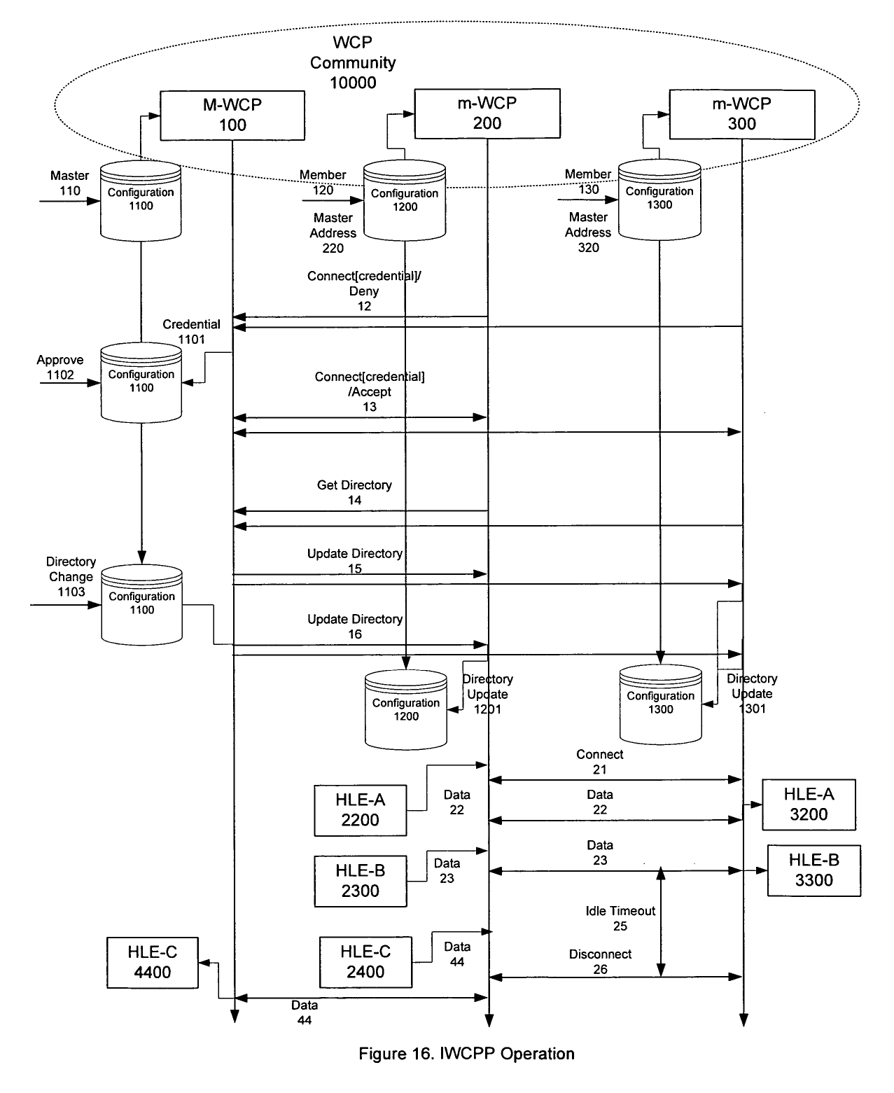

16. FIG. 16 illustrates an IWCPP Operation in accordance with embodiments of the invention

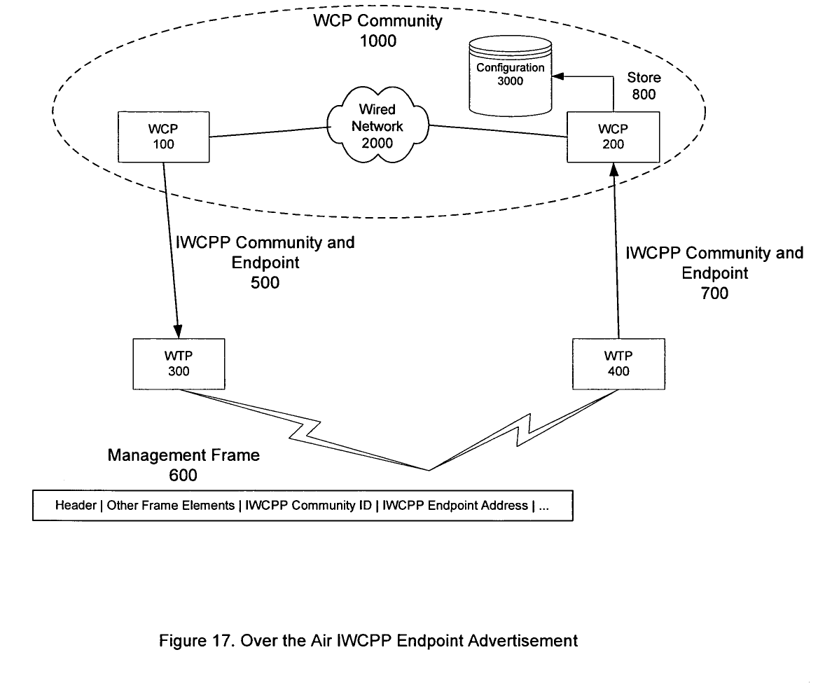

17. FIG. 17 illustrates an over the Air IWCPP Endpoint Advertisement in accordance with embodiments of the invention

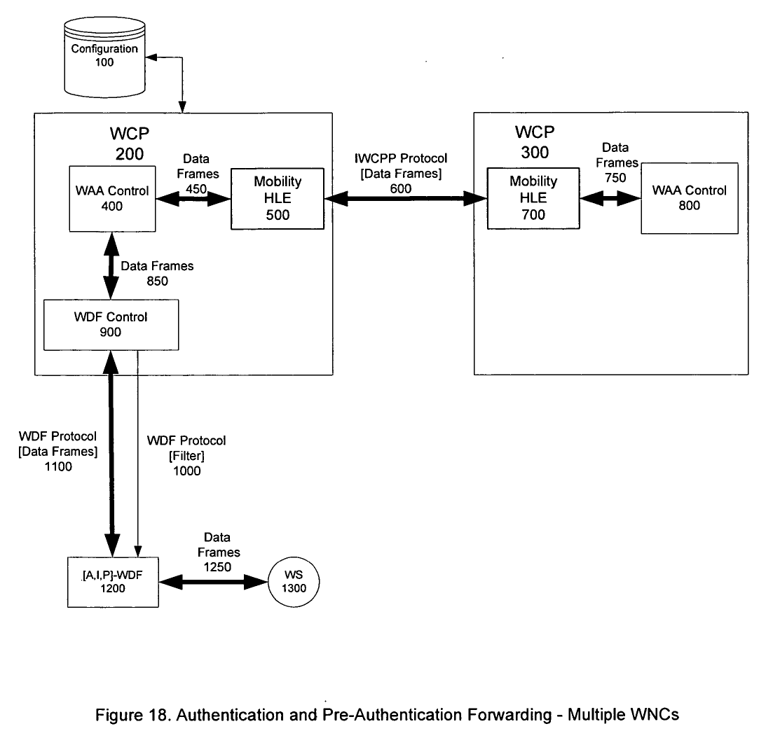

18. FIG. 18 illustrates Authentication and Pre-Authentication Forwarding—Multiple WNCs in accordance with embodiments of the invention

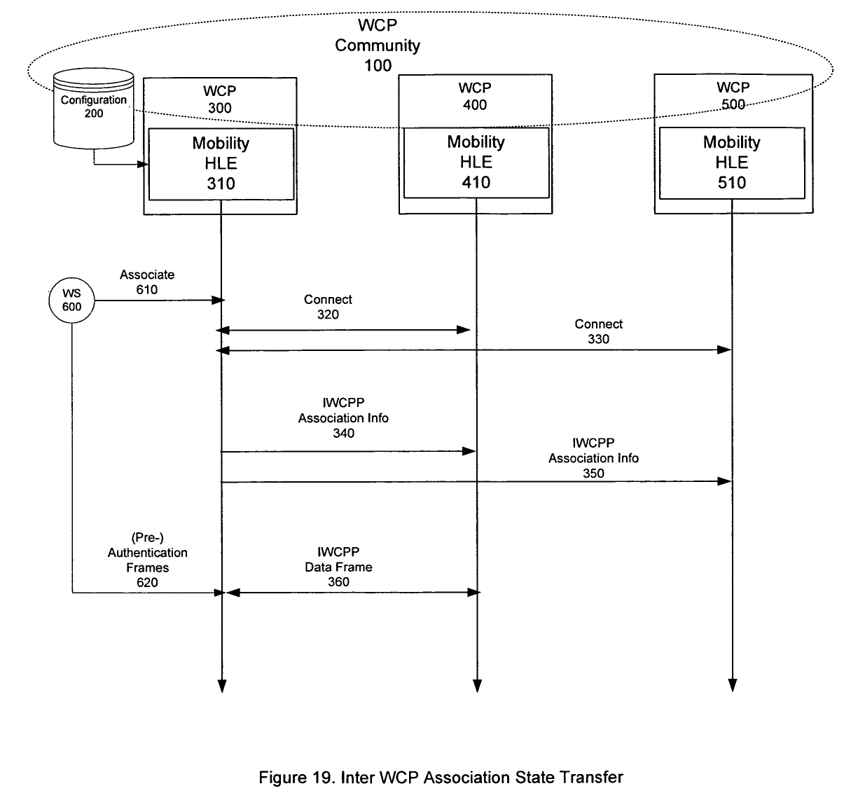

19. FIG. 19 illustrates Inter-WCP Association State Transfer in accordance with embodiments of the invention

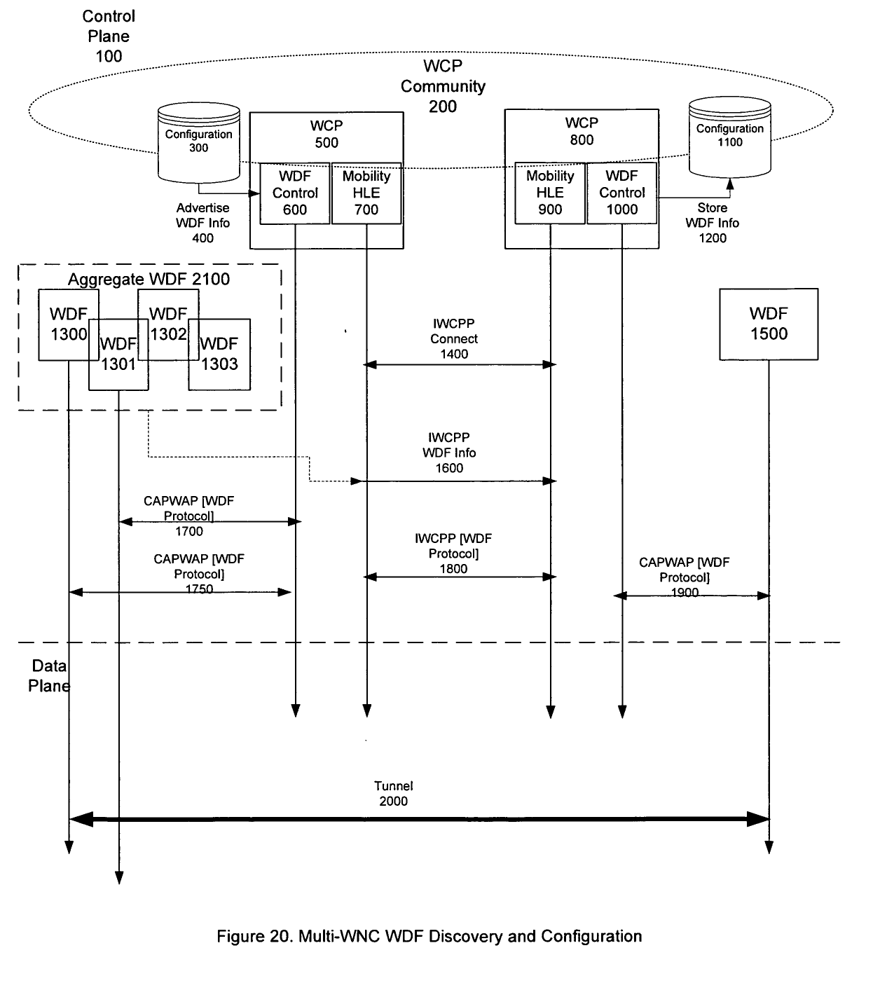

20. FIG. 20 illustrates Multi-WNC WDF Discovery and Configuration in accordance with embodiments of the invention

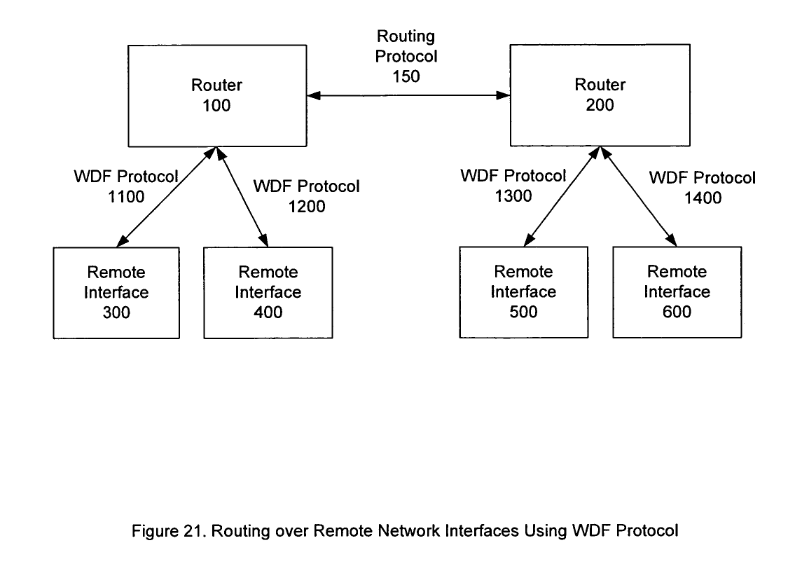

21. FIG. 21 illustrates Routing over Remote Network Interfaces using WDF Protocol in accordance with embodiments of the invention

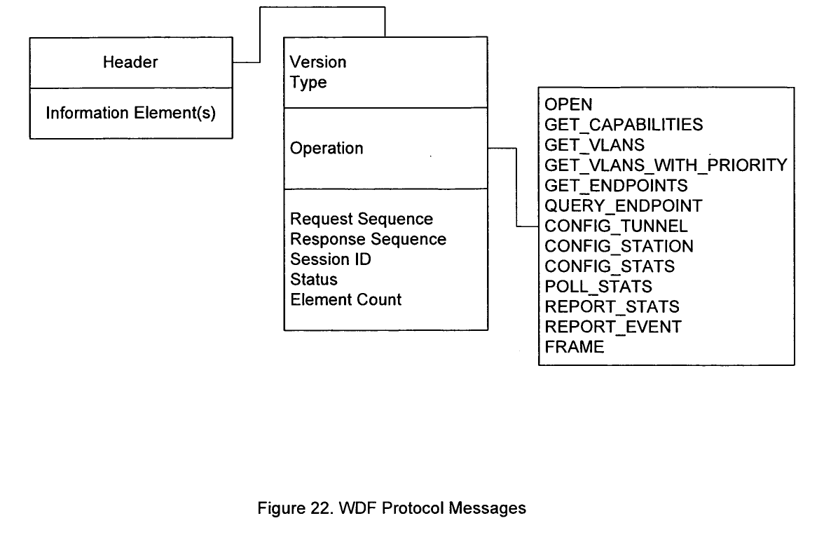

22. FIG. 22 illustrates WDF Protocol Messages in accordance with embodiments of the invention

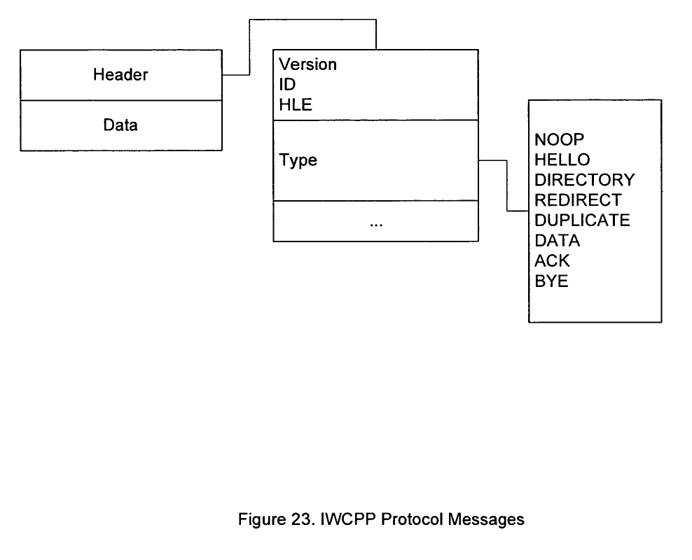

23. FIG. 23 illustrates IWCPP Protocol Messages in accordance with embodiments of the invention

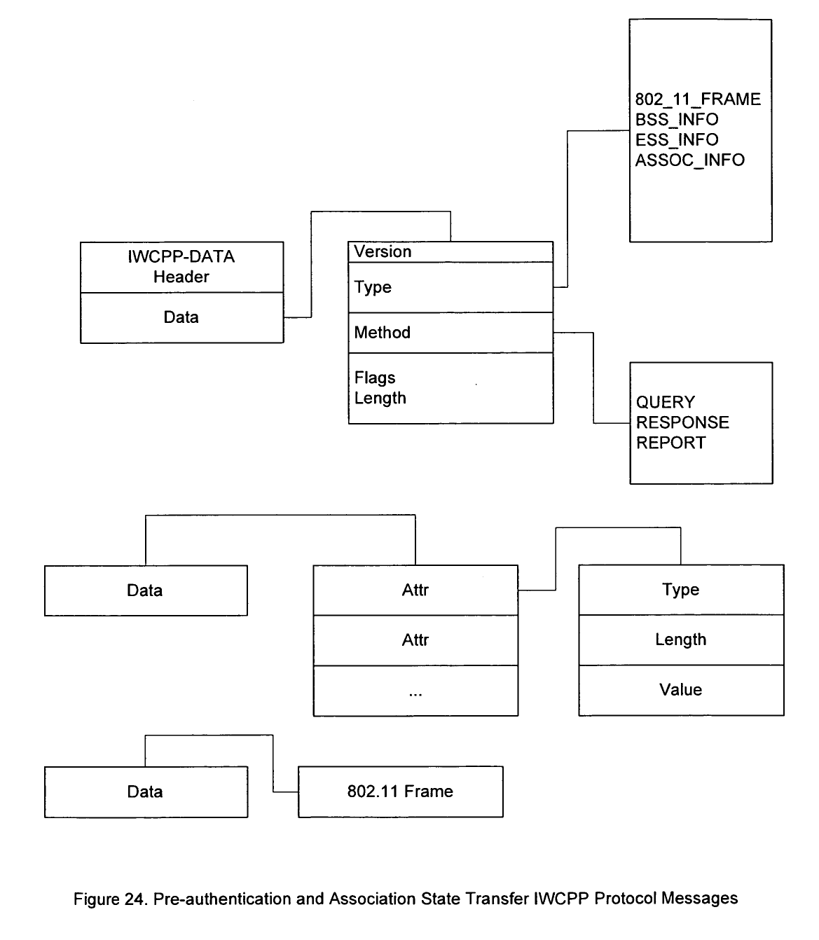

24. FIG. 24 illustrates Pre-authentication and Association State Transfer IWCPP Protocol Messages in accordance with embodiments of the invention

### DETAILED DESCRIPTION OF THE INVENTION

This invention describes systems and methods of logical wireless data forwarding for realizing large scale wireless networks.

Wireless Data Forwarding Architecture

As illustrated in FIG. 2, A WNC (500) is a device in the network that implements a logical Wireless Control Plane (WCP 100). A WCP includes two other logical elements of this architecture—a WDF control element (400) and a Wireless Authentication and Association (WAA) control element (300). The WDF and WAA control elements communicate for coordination of wireless client authentication and association with wireless data forwarding. For example when a wireless client authenticates and associates to a WTP controlled by a controller (500), WAA Control function (300) may invoke the WDF Control function (400) by means of a notification (200). Similarly, in this architecture, a WDF element (50) includes two logical elements—a WDF Agent element (80) and a Packet Forwarding Engine (PFE) element (60). WDF Agent element (80) is controlled by the WCP (100) using a WDF Protocol (600). This protocol may use a WiFi VPN protocol, other CAPWAP protocol or local IPC or API for transport of control messages between WCP (100) and WDF Agent (80). The WDF Agent (80) in turn controls the PFE element (60) using a local interface (70). PFE elements may be implemented in hardware or software.

A PFE element (61) may have one or more access radio ports (613,614,615), and have one or more network service ports (611,612,613,616). Some radio ports are used to provide wireless client access (614,615) where as other radio ports (613) may be used as a network port. Certain PFE elements (62) may have only network ports (621-627) and no radio ports. The network ports may be configured to be members of some number of logical Layer 2 networks—i.e. Virtual LANs (VLANs). PFE element may also have certain capabilities—such as tunneling encapsulations supported, capacity with respect to number of tunnels. PFE also maintains the necessary forwarding state for wireless data forwarding.

FIG. 3 is a logical view of a subset of sample wireless network of FIG. 1 where physical elements are replaced by logical elements. A WDF may be located at a WTP (700), another device in the network—such as a switch (600), or located at the WNC device (550) which itself may serve other network function such as Layer 2 switching or Layer 3 switching or Layer 3 routing or some combination thereof. A WCP (300) may also be standalone without any co-located WDF elements. WDF elements co-located with WTP serve as A-WDFs for wireless client data flows. Other WDFs serve as I-WDFs and P-WDFs for supporting wireless features such as mobility and centralized data flow control policy.

FIG. 4 is a logical view of an example multi-WCP, multi-WDF wireless network. Each WDF (500,600,700,800) in the wireless network is under the control of a single WNC (WCP) called its primary WNC (WCP). For example, WDF 500 has WCP 100 as its primary WCP. In order to support mobility of wireless clients between WTPs connected to different WNCs, and thus different logical WCPs, this invention describes an Inter-WCP Protocol (IWCPP 300). Using this protocol a WCP (100) may request another WCP (200) to configure a WDF for which it is the primary WNC in addition to controlling its own WDFs using the WDF protocol (900).

In this invention, a WDF Control element of WCP configures a mode for a subset of wireless data flows it controls. A network administrator may configure a mode that applies to wireless data flows for each WTP, BSS, ESS, or VLAN or a combination thereof in the network. Three modes of wireless data forwarding, DDF, CDF and CHDF that provide increasing scalability of wireless data flow control for mobility are described below.

Illustrated in FIG. 5 with a subset of sample wireless network of FIG. 1, Distributed Data Forwarding (DDF) is a mode in which tunnel [1200,1300,1400] s required for wireless mobility are only set up between WDFs located at WTPs (100, 200, 700, 800, 850, 900). The WDFs between which tunnels are established may have the same or different primary WCPs. For example WDF 700, and WDF 800 with tunnel 1200 between them are controlled by the same WCP 550 that controls the lower left part of the network. WDFs 850 and 900 with tunnel 1300 between them are controlled by different WCPs 550 and 300 respectively. This mode supports a deployment scenario where network devices other than WTPs have no special wireless data forwarding support or awareness. A special case of DDF mode is when no tunnels are set up between WDFs.

Illustrated in FIG. 6 with a subset of sample wireless network of FIG. 1, Centralized Data Forwarding (CDF) is a mode in which the tunnels [1200,1300,1400,1500] are setup between WDFs (100,700,900) located at WTPs and WDFs located at non-WTP devices (550,600). These non-WTP devices could be switches or routers in the wired network (600) and could host a WCP along with a WDF (550). In this mode, a WDF (900) located on a WTP may have tunnels [1300,1500] to other WDFs (550, 600) which potentially have different primary WCPs (550, and 300 respectively).

Illustrated in FIG. 7 with a subset of sample wireless network of FIG. 1, Centralized Hierarchical Data Forwarding (CHDF) is a mode in which a WDF located at a WTP tunnels all wireless data flows through it to a single WDF in the network. Typically, not necessarily, this WDF is co-located with the primary WCP of the WTP co-located WDF. In the illustration, WDF 700 tunnels data traffic to WDF 550 via tunnel 1200 on the switch where both WDFs are controlled by WCP 550. WDFs 100 and 900 tunnel traffic to WDF 600 [via tunnels 1400,1500]. A tunnel 1300 between WDF 600 and WDF 550 provides for mobility of wireless clients attached to WTPs controlled by WCP 300 roaming to WTPs controlled by WCP 550 and vice versa.

Although it is not illustrated here, it is important to note that the architecture of this invention allows a given WDF at a WTP to select different modes of wireless data forwarding for different wireless data flows as configured by its primary WCP. A more common case would be a WDF supporting a single forwarding mode for all the data flows through it.

WDF Protocol

Illustrated in FIG. 8, WDF Control element (200) of a WNC (100) controls the data flow through PFE (500) of an Agent it controls using WDF Protocol (1000) specified by this invention. WDF Protocol consists of messages that
Discover (1100) the capabilities (e.g. tunnel types, whether implemented in software or hardware, maximum number of tunnels supported), and configuration of the PFE (e.g. port VLAN membership)
Configure (1200)—create, delete, or modify—tunnels, including their properties, that originate or terminate at the WDF for supporting wireless data flows
Configure (1200) forwarding state and other properties for wireless clients whose wireless flows use a tunnel.

WDF Protocol is transport independent—it may use CAPWAP protocol (600) to transfer its messages from a WNC (100) to WDF (400) which has for its primary controller. It may use Inter-WCP Protocol (900), later described in this invention, to transfer its messages from a WNC (100) to another WNC (not shown) indirectly controlling the WDFs for which the other WNC is the primary controller—in this case the other WNC serves as a WDF protocol proxy to the WDF (400). When a WDF is co-located with a WNC, it may use a local IPC (700) mechanism or API (800) to control the WDF. The WDF protocol may also use another protocol based on IP, TCP or UDP (1000) as a transport. The WDF protocol has no built-in mechanisms for protecting the integrity and confidentiality of its messages—instead, it relies on its transport protocol (600,900) to provide the necessary protection.

FIG. 9 illustrates WDF Protocol operation. In this example, a WNC (20) controls three WDFs (30,40,50). Without loss of generality, in one deployment of wireless network where this invention is applicable, WDF 30 may be located on a WTP, WDF 40 may be located on WNC 20, and WDF 50 may be located on or has a primary controller other than WNC 20.

WNC 20 discovers the WDF elements (30,40,50) using a local configuration database (2000) or some other discovery mechanism such as that provided by this invention over Inter-WCP Protocol. WNC 20 and WDFs 30, 40 and 50 may boot up independently. The WDF Control element (1000) of WNC 20 engages in the several phases of the WDF protocol with the WDF element—Discovery (200), Tunnel Configuration (300), Client Forwarding State Configuration (400), Monitoring (500), and Teardown (600).

In the Discovery (200) phase, query messages are sent to the WDF elements. These messages are processed by the WDF Agent component of the WDF element. The query messages (D-30, D-40, D-50) request information about the WDF element which includes, but not limited to
Supported tunnel encapsulation types, including encryption and security types if any. Encapsulation types are, for example, L2 LWAPP, L3 LWAPP, GRE, UDP etc.
Tunnel encapsulation types implemented in hardware by the PFE
VLAN memberships for PFE ports at the WDF, if not configured on the WNC
Capacity with respect to number of tunnels supported, number of wireless clients supported.

The WDF Agents at the corresponding WDFs return the information requested via a query response message (RD-30,RD-40,RD-50).

Tunnels to support wireless station mobility are setup in advance based on configuration of a WNC (2000) or triggered (AA-Trigger 150) by a wireless client authentication and association to the wireless network. WDF Control performs the WDF selection process (described later in WDF Selection section of the invention) based on WNC configuration (2000), WDF information from the earlier discovery process, and the knowledge of wireless client Association WDF (A-WDF)—i.e. the WDF located at the WTP with the client radio attachment. Without loss of generality, this A-WDF could be WDF 30, and WDF 40 and WDF 50 are selected as I-WDF and P-WDF respectively for the wireless client.

The discovery process (200) continues where DF Control (1000) queries the WDFs—using another set of the query messages (D-30, D-40, D-50), selected for suitable tunnel endpoints. Response messages, for this set of messages (RD-30, RD-40,RD-50), contain the selected tunnel endpoint. WDF Agent can perform this selection based on local policy which might include load balancing among multiple tunnel types, reachability of the tunnel endpoint from the source or destination specified in the query message etc. Among other attributes, a endpoint query may request selection based on
wireless client VLAN or IP Subnet
wireless client BSS
Layer 3 Protocol (e.g. IP as Ethernet Type)
Multicast Group Address (Layer 2 or Layer 3)

Based on the endpoints selected, WDF Control configures tunnels (Tunnel 30-40, Tunnel-50) for wireless client data flows using tunnel configuration messages (TC-30, TC-40, TC-50). The same set of attributes of the data flow used for selection of the endpoint (e.g. VLAN, IP Subnet, BSS, Layer 3 Protocol, Multicast Group) specified in the tunnel configuration messages, so that only selected data flows use the tunnel. One aspect of the tunnel setup to be noted is that the tunnels are logical entities, shared by many wireless clients and data flows. In addition, a WDF Agent may map multiple tunnels setup using the configuration messages from its WNC to a single hardware tunnel.

Once the tunnels are set up, WDF Control (1000) updates the forwarding state associated with tunnels using Station Configuration (SC) messages (SC-30,SC-40,SC-50). This message enables the wireless client use of this tunnel. If data flows of a wireless client belong to multiple tunnels, as is the case for protocol (IP) based tunnels, WDF Control may use a split tunneling mode. In the split tunneling mode, multiple SC messages may be sent to add wireless client forwarding state to more than one tunnel. In one embodiment of this invention, IP traffic from the wireless clients with the same A-WDF may be using one IP-in-IP tunnel for IP traffic, and another GRE tunnel for non-IP traffic.

The WDFs, tunnels, and forwarding State are monitored (500) by the WDF Control (1000) element of WNC (20). WDF Control, as part of tunnel, client forwarding state configuration may have requested statistics to be collected. Alternatively, the PFE element may have detected packet errors (including decryption errors), or a new VLAN or IP Subnet is configured on a PFE network port. These events and statistics are communicated to the WDF Control (1000) by the WDFs using notifications (N-30, N-40, N-50). In the absence of notification or response to queries, WDF Control (1000) may mark the corresponding WDF as out of service, and configure another WDF with appropriate tunnels and forwarding state so that wireless network disruption is minimized.

Finally, the tunnels and forwarding state created can be deleted by WDF Control (1000) using teardown messages (T-30, T-40, T-50). Teardown typically happens because wireless clients move, or if a tunnel has been idle for a configured (2000) timeout. Where resources permit, tunnels may persist for the lifetime of the association between the WDF Control (1000) and the Agent (30,40,50).

Once tunnel configuration (300), and wireless client forwarding state configuration (400) are complete, wireless data traffic from the client can flow through the network. In the case when WDF 30 is A-WDF, WDF 40 is I-WDF, WDF 50 is P-WDF of the client, WDF 30 receives the client traffic over the air, tunnels to WDF 40 using Tunnel 30-40 which then tunnels to WDF 50 using Tunnel 40-50. WDF-40 is responsible for sending the client traffic over its PFEs' network port, potentially via a tunnel. This invention allows a null tunnel encapsulation type between WDFs; in this case traffic in that null tunnel uses native encapsulation of the PFE port which is typically the Ethernet or 802.2 SNAP/LLC frame format.

An important aspect of WDF protocol that may not be apparent from the above description, but would be obvious from the message formats specified in this invention, is that QoS attributes, filtering or classification rules, and security keys may be specified as part of the tunnel or forwarding state configuration. A few of these configurable attributes are
QoS assigned to a wireless station. For example, an indication that the wireless client associated using WMM or 802.11e mechanisms.
802.1D priority for the flows using a tunnel.
A classification rule that maps a flow to a 802.1D or a DSCP value.
Where applicable, security type, and protection keys for the tunnel or wireless client. Security type includes the encryption (or decryption) algorithm to be used and may include the authentication type used by the wireless client or flows through the tunnel.
The type of WDF relative to the wireless client whose forwarding state is being configured i.e. A-WDF, I-WDF, P-WDF. Note that a WDF may serve multiple of these roles.

FIG. 22 illustrates the set of message types and format of the messages used by the WDF protocol. These messages represent requests from WDF Control element of a WNC or responses from a WDF agent encompassing the following operations
OPEN—Open connection with the agent.
GET_CAPABILITIES—Get agent capabilities
GET_VLANS—Get list of served VLAN IDs
GET_VLANS_WITH_PRIORITY—Get VLANS IDS along with the priority of the VLAN. Used by an WDF aggregating WDFs with different priorities.
GET_ENDPOINTS—Get a list of tunnel endpoint IDs
QUERY_ENDPOINT—Query endpoint based on specified criteria—e.g. VLAN
CONFIG_TUNNEL—Configure a tunnel
CONFIG_STATION—Configure a station
CONFIG_STATS—Configure statistics
POLL_STATS—Poll to request statistics
REPORT_STATS—Report selected statistics
REPORT_EVENT—Report an asynchronous event including configuration changes, and errors
FRAME—An encapsulated frame e.g., an 802.1× frame

Each message contains a message header followed by one or more information elements that correspond to the message ID in the header. In addition, a WDF protocol message header contains a version, session ID, request and report sequence numbers.

The WDF Architecture and the WDF protocol, presented above in this invention, is flexible in accommodating a variety of WDF hardware and software capabilities and leveraging them to provide optimal wireless network services in a variety of network topologies.

WDF Selection, Tunnel and Client Forwarding State Configuration

An important function of WDF Control element of a WNC is selection of WDFs for a given wireless client flow. WDF Control methods described elsewhere in this invention ensure that forwarding tunnels (potentially null tunnels) exist for the wireless client traffic flow and creating forwarding state for the wireless client at the selected WDFs.

To set the stage for the WDF selection process of this invention, FIG. 10 shows, without loss of generality, roaming events (Roaming-500, Roaming-501) when a wireless client 50 changes it radio attachment point from WTP (WDF) 850 to WTP (WDF) 800 or WTP (WDF) 900. The target WDF may have the same primary controller as the source WDF of the roam (Roaming-500), or the controller may be different (Roaming-501). Typically, in 802.11 based wireless networks, the wireless client chooses its radio attachment point—in other words the A-WDF for its association with the wireless network.

In the above scenario, WDF 850 is directly to attached to VLAN 50 (VLAN-50), which for the purpose of this illustration is also the VLAN assigned to the client 50. When wireless client 50 associates to the wireless network, traffic for the wireless client may be placed by WDF 850 directly on to the wire—i.e. the P-WDF for the wireless client is the same as its A-WDF; no I-WDF would be necessary.

When Roaming-500 happens, the target of the roam (WDF 800) is not directly connected to the VLAN 50 assigned to the client. Instead, it is directly connected to VLAN 800 (VLAN-800). In this case, WDF Control element is responsible for choosing a P-WDF that is directly connected to VLAN 50 for wireless client 50. A suitable choice of P-WDF for this scenario would be WDF 550 co-located with WNC 550.

Alternatively, if Roaming-501 happens, the target of the roam (WDF 900) is not directly connected to VLAN 50 assigned to the client. Instead, it is directly connected to VLAN 900. In this case, a suitable choice of P-WDF for the wireless client is WDF 550 located at WNC 550, and a suitable choice, in Centralized Hierarchical forwarding mode, for I-WDF is WDF 600 co-located with Switch 600. In this scenario, WNC 300 and WNC 550 need to advertise their WDFs and coordinate their WDF protocol over Inter-WCP Protocol transport for setting up the necessary forwarding tunnels and client forwarding state—the mechanism for which is described later in this invention.

Clearly, WDF Control element's choice of WDFs for wireless client flows is a critical component of the wireless data forwarding described in this invention. The process by which WDF element makes this choice is illustrated by FIG. 11.

WDF (500) address and priority information is administratively specified or discovered in a WNC configuration database (2000) is made available to WDF Control function (400). As an example of discovery, a WTP always contains a WDF element; a WNC may detect WDF elements based on its configuration and share it with other controllers in the wireless network.

Dynamic information (1000) about WDF elements (500) is discovered using the WDF Protocol—Discovery mechanism (3000) specified earlier—and is available to WDF Control (400). This dynamic information includes VLANs configured at WDF (500) PFE ports—VLAN 600, 700—and tunnel encapsulation types supported by the PFE at the WDF (500).

When a wireless client (50) associates, or re-associates—i.e. establishes or re-establishes its radio attachment to the wireless networks, WAA Control (100) element of WNC co-located with WDF Control element (400) notifies (Notification 110) the WDF Control element (400) about client (50) of the client's radio attachment (A-WDF), VLAN assigned and other relevant information such as QoS attributes, cryptographic keys required for processing client traffic, MAC Address of the radio attachment (e.g. 802.11 BSSID) etc.

A P-WDF of highest priority is then selected by P-WDF selection element (200) from among the WDF's with a PFE port configured with VLAN assigned to client (50). Based on forwarding mode, I-WDF may also be selected (300). As an optimization, selection of P-WDF and I-WDF may be avoided if the radio attachment of the client does not change the A-WDF for the client—this may happen, for example, when the client reattaches to a different radio on the same WTP.

Tunnel configuration between A-WDF and P-WDF or A-WDF and I-WDF along with I-WDF and P-WDF may be dynamically triggered based on P-WDF and I-WDF selection (Notification 120, Notification 130) if suitable tunnels do not exist between WDFs. Suitable tunnel configuration may have been triggered by another client that associated to the wireless network earlier for which the same WDFs (pairwise) were chosen or tunnels were pre-established based on configuration 2000 (Pre-configure 140).

In one embodiment of this invention, the configuration (2000) that results in pre-configuration of the tunnels (Pre-configure 140) may be obtained from RF Data Collection functionality of RF Management elements co-located with WDF Control (400) on the same controller. Generally speaking, RF Data Collection components collect RF neighborhood information that is used for purposes such as Rogue AP or BS detection. The neighborhood information contains which BSSs or RF attachment points are neighbors are detected over the RF medium (air). Tunnels may be set up a priori between WDFs that are RF neighbors.

Finally forwarding state is configured (5000) is set up for the wireless client (50) based on the selected A-WDF, P-WDF and I-WDF information and the tunnels available as necessary between them. The client state is also stored (Store 150) by the WDF control (400) in its internal state tables (6000) for later use such as when the client re-establishes its radio attachment to a different WTP.

Without loss of generality of this invention, in order to address common wireless deployment scenarios and simplify wireless control flows, WDF Control element's WDF selection process may be endowed with administrative policy in the configuration database (2000). Based on policy, a WDF Control element may
give a wireless client's last P-WDF a preference or higher priority when selecting a P-WDF for the client's current radio attachment.
select a WDF co-located at a client A-WDF's primary WNC (with the WDF Control element) as the I-WDF—a special case of Centralized Hierarchical forwarding mode or make this selection on a per-VLAN basis.
locate a P-WDF always at a WDF co-located with a WNC—a special case of Centralized forwarding mode—with a preference given to the WNC containing the WDF Control element.
not use WDFs located on WTPs as a P-WDF or I-WDF unless in the distributed forwarding mode.
   WDF Operation and Data Flow

Thus far the description of the invention primarily focused on the control flow between various logical components of the wireless network. To understand how the state configured at WDFs via WDF protocol affects wireless data flow, one needs to examine the data flow between WDFs that is illustrated in FIG. 12. It is important to note that FIG. 12 represents one embodiment, not the only one, of the data flows that this invention allows.

The logical data flow in the figure shows, without loss of generality, two wireless clients (WS10, WS20). The result of control operations sets up a logical Layer 2 link between a client and the network—for example between WS10 and WC10, or WS20 and WC20 in the figure. As a wireless client roams and changes it radio attachment and consequently its A-WDF, and potentially its I-WDF and P-WDF elements, mobility feature provided using the mechanisms of this invention preserve this logical link.

For a wireless client, WS10 for example, its upstream data traffic to the network (DS in 802.11 terminology) flows through its A-WDF (100), optionally to its I-WDF (200) via tunnel Tun-1200 based on forwarding mode and then to its P-WDF (300) via tunnel Tun-2300 or via tunnel Tun-1300 directly to its P-WDF (300). A null tunnel is a degenerate case of tunneling where no tunnel encapsulation is necessary. To the rest of the wired network (N100), WS10 data traffic appears to originate at P-WDF (300).

Similarly for another (or the same) wireless client, WS20 for example, its downstream data traffic from the network flows through its P-WDF (600), optionally to its I-WDF (500) via tunnel Tun-5600 and then to its A-WDF (400) via tunnel Tun-4500 or via tunnel Tun-4600 directly to its A-WDF (400). Where the A-WDFs (100, 400) for the clients are the same and the clients are on the same VLAN, data from one wireless client (WS10) may flow to another (WS20) directly—in this invention such forwarding is controlled by administrative policy.

In short, the purpose of the control state set up by WDF Control elements of a controller at its WDFs (PFEs) is to enable the data flows described above. FIG. 13 illustrates the logic that can be implemented by the PFE, whether in hardware or software, to realize this forwarding.

PFE (1000) is a data plane element controlled by a WDF Control element via the WDF Agent element co-located with the PFE. Logically it may have a set of radio or service ports (RXS-10, TXS-10), and a set of network ports (RXN-10, and TXN-10). RXS-10 and TXS-10 could be the same physical port, but separately depicted in the picture to serve as ports where Layer 2 wireless (802.11, 802.16) frames are received and sent. Similarly, RXN-10 and TXN-10 could be the same set of network ports used for forwarding wireless client data traffic to the network and between the clients of a wireless network. These network ports may be wireless (802.11, 802.16), Ethernet or of another type. Although not shown in the FIG. 13, the methods of this invention are applicable to the case where there are multiple service ports and multiple network ports, and the case when there are no access radio ports located at a PFE.

WDF Control element creates PFE state (2000) via the WDF protocol to the agent—the state includes tunnel configuration state, wireless client forwarding state and potentially other configuration (1100). The packet forwarding of the PFE (1000) is illustrated in the figure as Process P-3000. Unless a received frame (P-100) follows a valid flow specified in P-3000, the packet is dropped.

A PFE (1000) receives a wireless frame (P-100) via its access radio port. As shown by the check F-100, only a PFE (WDF) that is A-WDF for a client is allowed to receive frames over the RF medium. If local forwarding is allowed (F-400), the PFE checks its WDF type relative to the destination address of the frame (F-700). If the PFE is the A-WDF for the destination address of P-100, it forwards the frame to its destination over the RF medium via port TXS-10. Otherwise a tunnel is selected (F-800) for P-100, followed by encapsulation (F-900) configured for the tunnel (e.g. GRE, LWAPP, UDP), and forwarded (F-1000) over its network port TXN-10.

It is important to note that the tunnel selection process (F-800) be cognizant of the direction of the data flow i.e. to a wireless station (downstream, From-DS) or from a wireless station (upstream, to-DS). This is because tunnel selection (F-800) in this invention uses source address attribute of a frame (P-100) for upstream tunnel selection, where as it uses destination address attribute for downstream tunnel selection. For 802.11 frames this is known—otherwise the frame direction is indicated in an encapsulation header or tunnels created can be unidirectional. In addition, tunnel selection selects the most specific tunnel applicable for the data flow—for example, if a tunnel is configured for a VLAN, and the also configured for VLAN and a Protocol (e.g. IP-in-IP), the latter is chosen if the frame belongs to the protocol. If no suitable tunnel can be selected, the frame is dropped.

When a frame (P-100) is received by Process P-3000 of PFE 1000 from one of its network ports (RXN-10), its WDF is one of the following (as can derived from FIG. 12)
A-WDF for the destination address of the frame. Its path through P-3000 is
   via Tunnel—RXN-10,F-300,F-200,F-500,F-600,F-700,F-1100,TXS-10 otherwise it follows the path
   Otherwise—F-300, F-700, F-1100, TXS-10
and is sent over the RF medium (in the normal case)
I-WDF for the source address and destination address of the frame. In this case the frame is forwarded via a tunnel to its P-WDF or A-WDF depending on the direction of the flow. Its path through P-3000 is
   via Tunnel—RXN-10,F-300,F-200,F-500,F-600,F-800,F-900,F-1000,TXN-10
   Otherwise—F-300, F-700, F-800, F-900, F-1000, TXN-10
I-WDF for the source address of the frame, but not the destination address. Its path through P-3000 is
   via Tunnel—RXN-10,F-300,F-200,F-500,F-600,F-800,F-900,F-1000,TXN-10
   Otherwise—RXN-10,F-300, F-700, F-800, F-900, F-1000, TXN-10
I-WDF for the destination of the frame, but not the source address. Its path through P-3000 is
   via Tunnel—RXN-10,F-300,F-200,F-500,F-600,F-700,F-800,F-900,F-1000,TXN-10
   Otherwise—F-300, F-700, F-800, F-900, F-1000, TXN-10
P-WDF for the source address, and the destination address of the frame. Its path through P-3000 is
   via Tunnel—RXN-10, F-300, F-200, F-500, F-600, F-1200, F-800,F-900,F-1000,TXN-10—in this case the frame is a wireless network frame and is directed at another wireless station.
   Otherwise—RXN-10, F-300, F-700,F-800,F-900,F-1000, TXN-10—the frame is received from the network, and is directed at a wireless station
P-WDF for the source address of the frame, but not the destination address. Its path through P-3000 is
   via Tunnel—RXN-10, F-300, F-200, F-500, F-600, F-1200, F-1000, TXN-10—the frame is directed at a wired host.
   Otherwise—RXN-10, F-300, F-700, F-800—the frame is dropped because there would be no suitable tunnel.
P-WDF for the destination address of the frame, but not the source address. Its path through P-3000 is
   via Tunnel—RXN-10, F-300, F-200—the frame is dropped because such a tunnel would be invalid
   Otherwise—RXN-10, F-300, F-700, F-800, F-900, F-1000, TXN-10—the frame is from a wired host to a wireless client.

In the above description related to FIG. 13, tunnel refers to a tunnel with non-empty encapsulation.

Another aspect, not illustrated in FIG. 13, but implied in the tunnel encapsulation (F-900) and Forwarding (F-1000) process, is the bridging or translation of frame formats between 802.11 (or 802.16) and Ethernet types. Certain encapsulation types, such as Layer 2 LWAPP, Layer 3 LWAPP, 802.11 in GRE that carry native 802.11 frames can be translated at the receiver. In certain cases, where encryption/decryption functionality is implemented at the WNC (an example of CAPWAP Split MAC Architecture), the translation may not be possible at the WDF that is the A-WDF for the wireless client originating the frame. For other encapsulation types, such as 802.3 in GRE or IP-in-IP, the frames need to be translated from wireless formats (802.11, 802.16) to Ethernet type prior to encapsulation. Furthermore, this invention does not prevent encapsulation types, such as IPSEC, that provide encryption or other security protection to the forwarded frames.

For data forwarding purposes, downstream frames with broadcast/multicast destination addresses on a VLAN are replicated to each of the tunnels for which wireless client forwarding state exists. Upstream broadcast/multicast frames from a wireless client reach the client P-WDF which forwards the frame in the reverse—downstream direction—in addition to sending it over the wired network.

WDF Forwarding—Mobility with a Single WNC

Based on the WDF Architecture, WDF Protocol, WDF selection, tunnel and client forwarding state configuration mechanisms described in this invention, wireless data forwarding and mobility can be provided for the wireless networks with a single WNC. One way to think about WDF forwarding is that the forwarding is based on source information to a P-WDF relative to a wireless station, and then the traditional destination-based forwarding. It is important to note that WDF forwarding does not forward packets between VLANs except tunnels over multi-VLAN or routed networks are used to provide logical attachment of wireless clients to their assigned VLAN.

Wireless Authentication and Association with Single WNC

As indicated in the WDF protocol description, WDF Control element may configure tunnel or wireless client specific packet filters. One application of these filters is to extract relevant control messages for authentication and forward them to the controller. For example, 802.11 standards allow for encrypted authentication, and pre-authentication to reduce the authentication latency during roaming. However no mechanism is specified for forwarding this 802.1X (Ethernet Type 0x888e) or pre-authentication (Ethernet Type 0x88C7) frames to a controller when the controller is separated from the WTP receiving these frames by a Layer 3 (IP) network.

FIG. 14 shows an application of this invention to serve this need in a wireless network—the top portion shows the control plane (1000) and the bottom showing the data plane (3000). It consists of a single controller whose logical control element is WCP 2000 containing WAA Control element 4000, and WDF Control element 5000.

WDF Control, as part of its support for wireless authentication and pre-authentication, configures data filters at some or all of its WDFs (100, 200, 300) using WDF Protocol (650,750,850). These filters select the required authentication or pre-authentication frames received at a WDF. When packets are received from a wireless client (10) at a WDF—either the A-WDF (100), I-WDF (200) or P-WDF (300) of the association, rather than forwarding packets matching the filter using the normal data flow, the packets are placed in the WDF Protocol (600, 700, 800) and sent to the WDF Control element (5000). The WDF Control element (5000) forwards these frames to the WAA Control element (6000) which is responsible for processing (or forwarding) these messages. It may also generate (or forward) responses to the wireless client along the reverse path.

The above mechanism allows 802.11 pre-authentication frames, addressed to a potential future radio attachment address (BSSID) of the wireless client (10), to reach the controller resulting in establishment of security state prior to the client (10) roaming to the future radio attachment. This removes the authentication latency for faster roaming. In addition, re-authentication of the a client (10) may occur during the current session with the wireless network. These re-authentication frames (e.g. 802.1X) are received at a WDF and may be encrypted using wireless standards. Filters appropriately installed and forwarding using this mechanism, can redirect the decrypted frames from the WDF where the decryption function is implemented. This allows a flexible placement of the wireless encryption/decryption function in the wireless network—for example, such placement may be selected on a per-client, per-VLAN, or per-BSS basis.

The mechanism of the invention described above can be used in other applications some of which are
Forwarding HTTP/HTTPS frames to a controller for implementing Web/HTTP(S) based authentication.
Packets received at the WDF without appropriate client state or error packets to the controller for wireless network monitoring.
Mirroring or sampling wireless packet flows.
   Inter WCP Protocol (IWCPP)

Single WNC based wireless network deployments are inadequate in providing the scalability and redundancy of wireless services in large scale, operational wireless networks. To serve this need, wireless networks are based on multiple WNCs that coordinate their operation in order to provide seamless wireless services. One example of such a service is roaming between WTPs connected to different WNCs. Another example is authentication and sharing of security state between controllers to provide faster roaming. One can envisage other services, such as redundancy between WNCs, load balancing, location, single point of management and features that can benefit from common methods and protocol between controllers.

This invention presents a protocol for Inter WCP communication—IWCPP—to address the above need. The protocol is executed between WNCs (each with a logical WCP) grouped into a community. FIG. 15 illustrates the layering and application of IWCPP.

IWCPP (1000) is a protocol between the logical WCP elements (300, 400) of wireless controllers (WNC 100, 200) in a community. The community is established and managed using IWCPP Control application (1100) that runs over IWCPP (1000). This in turn enables other applications for scaling wireless features to multi-controller wireless networks. Example IWCPP applications are Mobility Control (1200), WLAN Database Synchronization (1300), RF Management (1400). IWCPP protocol may be transported by other protocols such as CAPWAP (500), TLS (600), TCP (700), UDP (800), IPSEC (900) and inherits their security properties. One a non-limiting embodiment of IWCPP runs over IETF standard TLS (600) protocol.

IWCPP Control is a special application of IWCPP that is responsible for control of IWCPP. Among other things it
is responsible for discovery, and consistency of discovered information, of other WNCs (WCPs) in the community.
is responsible for connection establishment, monitoring and teardown
maintains a registry of wireless applications that use IWCPP to coordinate wireless features across WNCs using a peer-to-peer model. These applications are called IWCPP HLEs (Higher Layer Entities). Each HLE, such as Mobility Control, is assigned a specific unique identifier. IWCPP HLE denotes the HLE corresponding to the IWCPP control application.

HLEs at a WCP send and receive wireless control data to and from a remote HLE at another WCP using IWCPP. HLEs for mobility and security are described later in this invention. FIG. 16 illustrates the operation of IWCPP HLE and use of IWCPP by other HLEs.

A WCP Community (10000) is an administratively created group of WCPs (100, 200, 300) each with its own configuration database (1100, 1200, 1300). One member of the community (10000) is designated the master WCP (M-WCP 100) by administrative action (110). Similarly, other WCPs in the community (200, 300) are designated members of the community (m-WCP 120, m-WCP 130) and are also provisioned with the M-WCP (100) address (220, 320). Each member of the community stores the information about other WCPs in the community—called the directory—in its configuration database (1100, 1200, 1300). The master WCP (100) is also a member of the community with respect to coordination of wireless features across the community of WCPs.

A member WCP (200, 300) uses the IWCPP transport protocol (e.g. TLS) to connect to the M-WCP (100) of the community and presents appropriate credentials. In the case of TLS, an X.509 certificate is presented as part of the TLS connection setup. When another m-WCP (200, 300) attempts a connection to M-WCP (100), it does not immediately accept the connection (12), but stores the credential in its configuration database for administrative approval (1101). If the credential has already been approved, it allows the connection (13). While PKI infrastructure allows a credential (X.509 certificate) to be validated, administrative approval as indicated above would allow an ACL of who is allowed to join the community of WCPs. Alternatively, an administrator may designate automatic approval to join the community if the credential presented can be authenticated and trusted (e.g. a WCP presents a signed message using a public key in an X.509 Certificate, signed by a trusted Certificate Authority), contains a specific attribute and/or attribute value.

Following successful connection (13), a m-WCP (200, 300) may request (14) the directory of WCPs in the community (10000). M-WCP (100) updates the m-WCP (200, 300) with the current directory information as a response (15). The directory may also be updated by M-WCP (100) sending a directory update (16) to m-WCPs (200, 300) when the directory information changes at the master. An example of such a change would be when another WCP is allowed to join the community. The receivers of the directory (200, 300) stores it their respective configuration databases (1200, 1300) for use by the IWCPP HLE. Only the M-WCP (100) of the community is allowed to respond to directory requests and send updates to other members of the community, where as each m-WCP (200, 300) also maintain the directory in their configuration databases (1200, 1300). Information contained in the directory includes
IP and/or DNS address of the WNCs in the community
X.509 Certificate or other credential for each WNC in the community
Other attributes of each WNC, such as update sequence number of its configuration database to assist HLEs in maintaining a (loosely) consistent distributed database.

When a HLE (HLE-A 2200) at a WCP (200), say the Mobility Control HLE, sends a message (Data 22) to its peer HLE-A (3200) at WCP (300), IWCPP Control HLE establishes a connection (21) between the WCPs, if one does not exist already. The data (22) is queued locally until the connection is established (21) at which time it is sent to the peer WCP (300) and received at the corresponding HLE (3200). In another case when a HLE (HLE-B 2300, HLE-C 2400) at a WCP (200) sends messages (Data 23, Data 44), to peer HLEs (HLE-B 3300, HLE-C 4400), the IWCPP connection may already be established. In this case, the message is sent without the connection setup delay.

Connections between WCPs are dynamically established as described above. If a connection is idle for more than a configured period of time (25), it is disconnected (26). Where resources permit, and for WCPs controlling WTPs that are neighbors of each other over the RF medium, this idle timeout may be infinite.

FIG. 23 presents the set of IWCPP message types specified by the implementation header file.

IWCPP and RF Neighborhood

In order for a WCP to assist HLEs, in particular the HLEs that support mobility and security across WNCs in the community, IWCPP identification (Community Name, WCP ID) and its endpoint (IP/DNS, TCP Port) address may be advertised over the air in standard but extensible or additional management frames in addition to the radio attachment endpoint address (e.g. BSSID in 802.11) that is typically advertised. As an example, in 802.11 wireless networks, an information element can carry this information. Such an advertisement provides the mapping between the radio attachment and the WNCs controlling the WTP containing the attachment point to other WTPs that may be controlled by another WNC in a WCP community. RF Data Collection mechanisms at neighboring WTPs forward this mapping to their primary WNC which in turn leverages this information for coordinating wireless features across multiple controllers in the community.

FIG. 17 illustrates a WCP community (1000) in which WCP 100 and WCP 200 are members. WCP 100 communicates its community name and IWCPP endpoint information to WTPs (300) under its primary control. WTP 300 advertises this information using a management frame over the RF medium. This frame is received by another WTP (400) controlled by WCP 200, but part of the community (1000). WTP 400 sends this information to the WCP which controls WTP 400. Using this mechanism, WCPs in the controller may learn the fact that they are neighbors over the RF medium and the IWCPP endpoint information of the neighbor. This information is stored (800) in their configuration database (3000) for use by HLEs supporting wireless features across a community of wireless controllers.

This invention describes two applications of this mechanism later.

Wireless Authentication and Association with Multiple WNCs

FIG. 14 illustrated the installation of filters by a WCP at a WDF it controls using WDF Protocol and the resulting authentication (or pre-authentication) data frames being forwarded over the WDF Protocol to the WDF Control element of the WCP. These frames are received by WAA Control element of the WCP. These authentication frames may be addressed to the radio attachment point (e.g. BSSID) controlled by another WCP in the same WCP community as the WCP that receives it.

In the above scenario, as illustrated in FIG. 18, the AA Control component (400) of a WCP, via the mobility control IWCPP HLE (500), forwards the authentication (or pre-authentication) frames (450) via IWCPP (600) to the neighboring WCP (300). The neighborhood and WCP addressing information is either administratively configured, discovered and made available in the configuration database (100) via another IWCPP HLE providing data synchronization, or discovered and made available in the configuration database using the mechanism described earlier in the invention. Using IWCPP as a transport (600), the AA Control element on the other controller completes its authentication exchanges with the wireless client (1300). In this example, authentication frames from the wireless client (1300) follow the path
to its radio attachment point (A-WDF) and to a WDF (1200) where the filter is installed (i.e. A, I, or P-WDF for the association)
to the WDF Control element (900) of the WCP (200) controlling the WDF (1200)
to the WAA Control element (400) of the WCP (200)
to Mobility IWCPP HLE (500) at WCP (200)
to Mobility IWCPP HLE (700) at another WCP (300) which controls the radio attachment to which the data frames (1250,850,450,750) are addressed.
to the WAA Control element (800) at WCP (300)

Authentication data frames to the wireless client (1300) from WAA Control (800) at WCP (300) follow the reverse of the above path.

In order to optimize the pre-authentication mechanism described above and sharing of association state below, as illustrated in FIG. 19, a mobility control IWCPP HLE (310) at a WCP in a community (100) may create an IWCPP connection (320,330) to neighboring WCPs (400, 500) in the community (100) when a wireless station (600) associates or re-associates (610) to the wireless network. Using the IWCPP connection, the association state, which includes security state, negotiated for the current association is transmitted (340, 350) to the neighboring WCPs (400, 500) in the community (100). This association state includes, but not limited to
Authentication Type, Key Management Type, Encryption Type for the association
Security Keys for the association. For example, for 802.11-based networks using 802.1X, the PMK negotiated for the association.
VLAN assigned to the wireless client
MAC Address of the radio attachment (A-WDF) of the client. In 802.11 networks, this is the BSSID of the radio attachment.
WDF endpoint information (A-WDF, I-WDF, and P-WDF) for the wireless client.
MAC and/or IP Address of the wireless client
Session timeout for the client association after which the security state is no longer valid.
Idle timeout for the wireless client association

Subsequent pre-authentication data frames received at WCP 300 are sent to, for example, WCP 400 in an IWCPP data frame (360) using the connection already established (320).

The mechanisms of this invention described above provide pre-authentication and association state transfer mechanisms in a large wireless network controlled by cooperating WNCs organized as a WCP community. These mechanisms avoid the re-association latency, of which establishment of security state is a big component, in wireless client roaming in these types of networks.

The IWCPP messages for pre-authentication and transfer of association state, including security state and related configuration, are not illustrated in FIG. 24. These messages are transferred in the IWCPP data messages between IWCPP Mobility Control HLEs on different WCPs.

WDF Forwarding—Mobility with Multiple WNCs

WDF Forwarding and mobility support in multi WNC wireless network is similar to that of a single controller, except that the WDF Control element on a WNC considers WDFs with other primary controllers in the community for its WDF selection. In particular, the P-WDF selection.

As illustrated in FIG. 20, a WCP (800) learns of WDFs (1300) not directly controlled by it from other WCPs (500) in the community (200) by means of administrative configuration (400) or via WDF advertisements (1600) it receives from other members (500) of the WCP community. Such an advertisement includes the ID and potentially the endpoint information for WDF element being advertised and is stored (1200) in the receiving WCP (800) configuration (1100).

During the WDF selection process described earlier in this invention, a WDF Control element (1000) of a WCP (800) executes the WDF Protocol over IWCPP (1800) as transport using IWCPP Mobility HLEs (700, 900) to communicate with its peer—the WDF Control element (600)—at another WCP in the community (200). The peer (600) in turn executes WDF Protocol (1750) with WDF elements (1300) it directly controls over a transport such as CAPWAP.

As a scalability optimization to minimize the number of WDFs advertised (1300, 1301, 1302, 1303), a WDF Control element may aggregate its WDFs and advertise a single WDF (WDF 2100) to other WNCs in the community. This mechanism allows multiple WDFs to be effectively shared while preserving the generality of the invention.

In another embodiment of this invention that provides support for Centralized-Hierarchical wireless data forwarding mode, a WCP may only advertise a WDF co-located with it and not any WDFs located on a WTP it controls to other WCPs in its community. This invention does not require a special WDF advertisement protocol message, although it does not preclude it. A WDF control element at a WCP may assume the existence of a WDF element at another WCP and attempt to open a connection to the WDF agent co-located with the other WCP thereby discovering it.

Routing over Remote Interfaces using WDF Protocol

In routed networks (e.g. IP Networks), router elements execute a routing protocol, such as PIM, OSPF, BGP between them to
Discover the networks connected to other routers via their local network interfaces
Setup forwarding state/routing tables for the local data plane for packet forwarding over local interfaces

The WDF Protocol presented in this invention extends the routing framework where by a router element, such as WDF Control element of a WCP, executes routing protocols over remote network interfaces. These interfaces could be wired or wireless network interfaces.

In one embodiment of this invention illustrated in FIG. 21, a router element (100) discovers, configures and monitors its remote network interfaces (300, 400) using the WDF protocol (1100, 1200) while advertising the networks connected to these interfaces to other routers (200) in the network for use by the routing protocol (150). This type of remote routing provides routing capabilities to network elements at the edge of the network, while removing the complexity of executing the routing protocol from, typically less powerful, access devices.

### CONCLUSION

The implementations and enhancements described in the foregoing are for example purposes only. Many variants, alternatives, and modifications shall be apparent to those skilled in the art.

1. A computer network system for forwarding packets through an integrated wired-wireless network, wherein the network supports wireless communication based on one more wireless communication protocols including 802.11, WiFi, 802.16, and WiMax, the system comprising:
one or more wireless data forwarding controllers (WDF controllers), each of which comprises one or more software modules resident upon one of a switch, router, bridge and other network device resident on the network, wherein the one or more wireless data forwarding controllers are in communication with one another via one or more protocols at layers 2 through 7;
a plurality of wireless data forwarding elements (WDF elements), each of the wireless data forwarding element comprising one or more software modules, each of the wireless data forwarding elements associated with a primary wireless data forwarding controller, the primary wireless data forwarding controller selected from the one or more wireless data forwarding controllers, wherein each of the wireless data forwarding elements is located on one of a wireless access point, a wireless Base Station, a networking switch, a router or another device in the network, wherein each wireless data forwarding element is in communication with the primary wireless data forwarding controller associated therewith via one or more protocols at layers 2 through 7.

2. The computer network system of claim 1, wherein one or more of the wireless data forwarding elements includes a wireless data forwarding agent, the wireless data forwarding agent including one or more software modules controlled by the primary wireless data forwarding controller, and a packet forwarding engine (PFE), the packet forwarding engine comprising software that accesses ports for one or more of wireless packet transmission and transmission of packets over a fixed-wire network.

3. The system of claim 1 wherein the one or more wireless data forwarding elements are in communication with the one or more wireless data forwarding controllers via one or more of a WiFi VPN protocol, CAPWAP protocol, intra-process API, Inter-Process Communication (IPC), and IWCPP.

4. The system of claim 3 where the Wi-Fi VPN, IWCPP or CAPWAP protocol provides message integrity and/or encryption of protocol messages.

5. The system of claim 3 where the wireless data forwarding Controller is pre-configured with the wireless data forwarding element for the VLAN membership for its packet forwarding engine network ports, or is otherwise operative to query the wireless data forwarding element for the VLAN membership for its packet forwarding engine network ports.

6. The system of claim 3 where the WDF Controller is either configured with or queries the WDF element for supported tunnel encapsulation types, hardware acceleration support, encryption support and WDF element or PFE capacity related to number of tunnels and wireless stations.

7. The system of claim 3 where the WDF Controller is either configured with or queries the WDF element for a suitable tunnel endpoint for a given BSS, VLAN, IP Subnet or Multicast Group.

8. The system of claim 7 where the tunnel endpoint is one of a source for the tunnel and a tunnel destination.

9. The system of claim 7 where information returned for the tunnel endpoint includes tunnel attributes, which may include one or more of tunnel encapsulation type, wherein the tunnel encapsulation type may be selected from one or more of GRE, UDP, and LWAPP, an indication of whether the tunnel is hardware accelerated, and information regarding encryption and integrity protection algorithms supported.

10. The system of claim 3 where the WDF Controller is operative to directly request a WDF element and indirectly request the associated PFE to configure a data forwarding tunnel to be used and shared for wireless data flows that belong to one or more of a Security Type, BSS, VLAN, IP Subnet, Layer 3 Protocol, Multicast Group based on tunnel endpoint information returned by the WDF element.

11. The system of claim 3 where the WDF Controller is operative to request a WDF element, and indirectly the associated PFE, to enable data flow for a wireless client using a configured tunnel.

12. The system of claim 10 where the tunnel configuration includes one or more of an indicator of whether or not cryptographic protection is enabled for data from the tunnel, wireless station, Security Type, BSS, VLAN, IP Subnet, Layer 3 Protocol, and Multicast Group using the tunnel.

13. The system of claim 3 where the WDF Controller is operative to provision a WDF element with one or more of cryptographic keys, cryptographic algorithm types for integrity and privacy protection of data to or from a tunnel, wireless station, Security Type, BSS, VLAN, IP Subnet, Layer 3 Protocol, Multicast Group.

14. The system of claim 3 where the WDF Controller is operative to provision the WDF element with quality of service parameters properties.

15. The system of claim 3 where the WDF Controller is operative to provision the WDF element with filtering rules where packets are captured and forwarded to other WCP Controller components via one or more of WiFi VPN, CAPWAP and another protocol, and where such packets may include one or more of 802.1X/EAPOL packets used for authentication and key management, 802.11i pre-authentication packets, HTTP and HTTPS packets for web-based authentication, and packets received at the WDF element that have no local forwarding state.

16. The system of claim 3 where the WDF Controller is operative to request the WDF element, and indirectly the PFE, to collect statistics for the tunnel, wireless station, Security Type, BSS, VLAN, IP Subnet, Multicast Group configured by the WDF Controller.

17. The system of claim 1 wherein the WDF controller is operative to select a wireless data forwarding mode from one of a Distributed, Centralized or Centralized-Hierarchical mode, based on the configuration of an access point, BS, BSS, ESS, SSID or VLAN in the wireless network.

18. The system of claim 1 where the WDF Controller monitors the liveness and operation of the WDF elements for which it is the primary WDF controller to ensure continuous availability of a wireless portion of the network.

19. In the computer network system of claim 1, a method of configuring the network, the method comprising:
in response to a wireless client associating to the network, invoking the WDF Controller, invoking the WDF controller including assigning one of a VLAN and an IP subnet;
selecting one or more of an A-WDF, P-WDF and an I-WDF, wherein the one or more of the A-WDF, I-WDF and P-WDF may be located on devices that are directly connected, mutually separated by a Layer 2 network, or mutually separated by a Layer 3 network.

20. The method of claim 19 where the A-WDF is located at an Access Point or a base station at which the wireless client is associating or attaching itself to the network.

21. The method of claim 19 where the P-WDF is selected from among the set of WDFs whose PFE ports are members of the VLAN assigned to the wireless station.

22. The method of claim 19 where the selection of P-WDFs is prioritized based on administratively configured priority of WDFs.

23. The method of claim 19 where the P-WDF for the current wireless client association is given a higher priority over other WDFs that could be chosen as P-WDF when the wireless client reassociates.

24. The method of claim 19 where the P-WDF located at the WDF Controller for the A-WDF is given a higher priority over other WDFs that could be chosen as P-WDF when the wireless client associates or reassociates.

25. The method of claim 19 where P-WDF is located on one of an access point or a BS when Distributed data forwarding mode is selected

26. The method of claim 19 where P-WDF is located on a switch, router, the WDF Controller or other non-AP, non-BS device in the network when Centralized or Centralized-Hierarchical data forwarding modes are selected.

27. The method of claim 26 where P-WDF is the same for all clients sharing the same A-WDF, and wherein the P-WDF may be located on a WDF Controller.

28. The method of claim 26 where P-WDF is the same for all clients sharing the same A-WDF and belonging to the same VLAN, and wherein the P-WDF may be located on a WDF Controller

29. The method of claim 19 where I-WDF is located on one of a switch, a router, a WDF Controller, and another type of device in the network when Centralized-Hierarchical data forwarding mode is selected.

30. The method of claim 29 where WDF located at the WDF Controller for the A-WDF is given priority over others in the selection of I-WDF.

31. The method of claim 29 where I-WDF is the same for all the clients sharing the same A-WDF, and the I-WDF is located on the primary WDF Controller for the A-WDF.

32. The method of claim 29 where I-WDF is the same for all the clients sharing the same A-WDF and belonging to the same VLAN, and I-WDF is located on the primary WDF Controller for the A-WDF.

33. In the computer network system of claim 1, a method of establishing data forwarding tunnels by a WDF Controller between WDF elements for which it is the primary controller to support wireless data flows, the method including one or more of the following steps:
connecting a wireless client to an associated A-WDF wirelessly, to another wireless client with the same A-WDF provided the clients belong to the same VLAN;
connecting the wireless client to the A-WDF wirelessly, and optionally to an associated I-WDF and P-WDF, to a wired host over one of a Layer 2 or Layer 3 network;
connecting a wired host over one of a Layer 2 network and a Layer 3 network to the P-WDF of the wireless client and then the A-WDF of the wireless client;
connecting the wireless client to its A-WDF, optionally to its I-WDF, to its P-WDF, via a Layer 2 or Layer 3 network, to a second wireless client via a P-WDF for the second wireless client, and optionally to an I-WDF and A-WDF for the second wireless client.

34. The method of claim 33 where tunnels are established when a wireless station associates or re-associates to the network.

35. The method of claim 33 wherein tunnels are pre-established by one or more of administrative action, WTP neighborhood information derived from RF Data Collection, and WTP neighborhood information administratively configured.

36. The method of claim 33 where a data forwarding tunnel is established between an A-WDF and a P-WDF selected for a wireless client using the method of claim 19 when Distributed or Centralized data forwarding mode is selected.

37. The method of claim 33 where a data forwarding tunnel is established between an A-WDF and an I-WDF selected for a wireless client using the method of claim 19 when Centralized-Hierarchical data forwarding mode is selected.

38. The method of claim 33 where a data forwarding tunnel is established between an I-WDF and a P-WDF selected for a wireless client using the method of claim 19 when a Centralized-Hierarchical data forwarding mode is selected.

39. The method of claim 19 where a WDF Agent and its PFE are configured not to forward traffic between wireless clients sharing the same A-WDF even when the wireless clients belong to the same VLAN.

40. The method of claim 39 where the configuration is based on one or more of a Security Type, VLAN, IP Subnet, BSS, ESS, Layer 3 Protocol, Multicast Group, wireless client.

41. A computer network system for coordinating integrated wireless-wired network functions between a community of wireless controllers in the same administrative domain in a network, the system comprising:
one or more wireless controllers that implement a logical Wireless Control Plane (WCP), the one or more wireless controllers located in one or more of a server, switch, router and another device in the network;
one or more WDF Controllers in the wireless controller;
one or more WAA Controllers in the wireless controller;
wherein the one or more wireless controllers are operative to perform wireless application coordination, which may further include one or more of the following functions: wireless data forwarding, mobility, fast roaming, authentication, load balancing, redundancy, RF management, configuration management, and network monitoring.

42. The system of claim 41 where a single WCP at a controller in the community is administratively designated as a Master WCP (M-WCP), and one or more other WCPs are member WCPs (m-WCPs), where
each M-WCP maintains a directory of WCPs in the community,
each M-WCP maintained directory includes attributes for each WCP in the community, including one or more of their IP, DNS or other address, Public-Key and X.509 Certificate,
each m-WCP is provisioned with an address of M-WCP, the address selected from one or more of an IP address and a DNS address, each m-WCP communicates with another m-WCP or M-WCP in the community using a secure protocol, which secure protocol may be one of TLS, IPSEC, and 802.11i.

43. The system of claim 41, wherein the m-WCP is operative to connect to the M-WCP and present one of a Public-Key Certificate, X.509 Certificate and other credential as part of a standards based protocol to be administratively approved before it is allowed into the community.

44. The system of claim 41 where m-WCP properly admitted to the community is operative to download the directory, update the directory from M-WCP at start up, and update the directory when notified by M-WCP of directory changes.

45. The system of claim 41 where connections between WCPs in the community are established dynamically, and shared between various wireless network coordination functions.

46. The system of claim 45 where the connection establishment and configuration sharing between WCPs in the community is based on current WCP neighborhood configuration.

47. The system of claim 45 where a connection is terminated when it is no longer in use based on an aging policy.

48. The system of claim 45 where WCP neighborhood is inferred based on mobility patters of wireless clients.

49. The system of claim 45 where WCP neighborhood is inferred based on RF Neighborhood information derived from RF Data collected at the WTPs where such information about neighboring WTPs includes one or more of SSID of ESSs advertised by neighboring WTP, BSSID advertised by neighboring WTP, identities or addresses or ID of the WCP in the community controlling the WTP, and signal strength.

50. The system of claim 41, further comprising:
one or more WDF elements in the wireless controllers, each of the one or more WDF elements including a PFE.

51. A system of communication of wireless client authentication and association information, the system comprising:
a computer network including fixed-wire and wireless communication;
one or more wireless clients in communication with the computer network;
two or more neighboring controllers in a community, wherein the system is operative to perform one or more of the following:
(a) one or more of the following wireless stations are operative to roam between one of a first Access Point and a first Base Station directly controller by a first controller to one of a second Access Point and a second Base Station directly controlled by a second controller,
(b) determine whether RF data collected by one of a first AP and a second BS directly controlled by the first controller indicates that one of a second AP and a second BS directly controlled by the second controller is an RF neighbor;
(c) determine whether the two or more controllers administratively configured as neighbors.

52. The system of claim 51 in which a wireless client authentication and association state at one controller is communicated to a neighboring controller using IWCPP or other protocol where the state may include one or more of:
security type, authentication type, and encryption type for the association,
encryption keys for the association,
VLAN assigned to the wireless client,
BSSID, identifier/identity of one of an AP and a BS for the association,
A-WDF, I-WDF, and P-WDF identity and endpoint information for the association,
one of a MAC Address and an IP Address of the wireless client,
other policy attributes that may result from authentication.

53. The system of claim 52 in which a controller is operative to:
send to the neighboring controllers wireless client state information when the client successfully authenticates and associates with an AP or BS directly controlled by the controller,
respond to a neighboring controller request with state information when the client associates with an AP or BS directly controlled by the neighboring controller or when the RF data collected by the neighboring controller indicates that a station may potentially roam to an AP or BS in its direct control.

54. The system of claim 52 in which a controller is operative to send to a set of one or more neighboring controllers when the wireless client indicates, via a management, control or data message, that it intends to roam to another AP or BS directly controlled by a controller in the set.

55. A method of authenticating a wireless client to one of an AP and a BS directly controlled by a first controller, the method comprising:
processing messages in an authentication exchange from the wireless client addressed to AP or BS controlled by the first controller that are received at an AP or BS directly controlled by a second controller, further including:
encapsulating, at the AP or BS controlled by the second controller, the messages in one of a WiFi VPN and CAPWAP protocol addressed to the second controller,
receiving and decapsulating the messages at the second controller;
encapsulating the messages in one of IWCPP and another protocol addressed to the first controller,
decapsulating the messages at the first controller;
processing the messages in authentication exchange from the first controller addressed to the wireless client and sending the messages to an AP or BS directly controlled by the second controller, processing the messages further including:
encapsulating the messages in one of IWCPP and another protocol addressed to the second controller,
decapsulating the messages in one of WiFi VPN and CAPWAP protocol addressed to the AP or BS directly controlled by the second controller,
sending the messages wirelessly from one of the AP and the BS controlled by the second controller.

56. The method of claim 55 where the authentication is defined by one of 802.11 i, WPA2, WPA, 802.1x, and 802.16 standards.

57. The method of claim 55 where the second controller determines the address of the first controller from the destination addressing information of the authentication messages based on one of:
an administratively configured mapping of an AP or a BS MAC address or a BSSID to the address of the controller,
a mapping inferred from RF Data collection at the AP or BS directly controlled by the controller where the RF Data collected includes the controller address or identity,
a controller advertising to neighbors or all other controllers in the community information about APs or BSs directly controlled by the controller.

58. A computer network system for forwarding packets through an integrated wired-wireless network, wherein the network supports wireless communication based on one more wireless communication protocols including 802.11, WiFi, 802.16, and WiMax, the system comprising:
one or more wireless data forwarding controllers (WDF controllers), each of which comprises one or more software modules resident upon one of a switch, router, bridge and other network device resident on the network, wherein the one or more wireless data forwarding controllers are in communication with one another via one or more protocols at layers 2 through 7;
a plurality of wireless data forwarding elements (WDF elements), each of the wireless data forwarding element comprising one or more software modules, each of the wireless data forwarding elements associated with a primary wireless data forwarding controller, the primary wireless data forwarding controller selected from the one or more wireless data forwarding controllers, wherein each of the wireless data forwarding elements is located on one of a wireless access point, a wireless Base Station, a networking switch, a router or another device in the network, wherein each wireless data forwarding element is in communication with the primary wireless data forwarding controller associated therewith via one or more protocols at layers 2 through 7;
wherein the system is operative to support the discovery of WDF elements by WDF Controllers in a community other than the primary WDF Controller for the WDF element, wherein such discovery is supported using one of IWCPP and another discovery protocol.

59. The system of claim 58, wherein a WDF Controller advertises administratively permitted WDF elements directly controlled by it to other WDF controllers.

60. The system of claim 58 wherein a first WDF Controller discovers the capabilities of a WDF element directly controlled by a second WDF Controller by directing the queries to the second WDF controller via one of IWCPP and another communications protocol.

61. The system of claim 58 where a first WDF Controller indirectly controls a WDF element directly controlled by a second WDF Controller by directing control messages to the second WDF controller via one of IWCPP and another protocol.

62. The system of claim 58 where a WDF Controller aggregates a subset or all of its WDF elements into a logical WDF element for advertising to other WDF Controllers in the community and processing queries and control messages addressed to the logical aggregate and translating them for processing by its WDF elements.

63. The system of claim 1, wherein the system is operative to establish data forwarding tunnels between WDF elements with identical or different primary controllers within a community to support wireless data flows that include one or more of a wireless client to its A-WDF over the air, optionally to its I-WDF, to its P-WDF, to a wired host over a Layer 2 or Layer 3 network,
a wired host over a Layer 2 or Layer 3 network to a P-WDF of a wireless client, optionally to its I-WDF,
a wireless client to its A-WDF, optionally to its I-WDF, to its P-WDF, via a Layer 2 or Layer 3 network, to another wireless client via its P-WDF, optionally I-WDF, and A-WDF.

64. The system of claim 63 where the WDF elements include those directly controlled by a Controller and those discovered using method of claim 58.

65. The system of claim 63 where a data forwarding tunnel is established between A-WDF and P-WDF selected for a wireless client using method of claim 19 when Distributed or Centralized data forwarding mode is selected.

66. The system of claim 63 where data forwarding tunnel is established between A-WDF and I-WDF selected for a wireless client using method of claim 19 when Centralized-Hierarchical data forwarding mode is selected.

67. The system of claim 63 where data forwarding tunnel is established between I-WDF and P-WDF selected for a wireless client using method of claim 19 when Centralized-Hierarchical data forwarding mode is selected.

68. The system of claim 63 where tunnels are established when a wireless station associates or re-associates to the wireless network.

69. The system of claim 63 where tunnels are pre-established by one of administrative action, WTP neighborhood information derived from RF Data Collection, and WTP neighborhood information that is administratively configured.

70. The system of claim 63, where the data flows include a first wired host over a Layer 2 or Layer 3 network to a second wired host.
